(19) United States
(12) Patent Application Publication
(10) Pub. No.: US 2016/0376982 A1
(43) Pub. Date: Dec. 29, 2016

(54) Highly Efficient Two-Stroke Internal Combustion Hydraulic Engine with a Torquing Vane Device Incorporated

(71) Applicant: Ricardo Daniel ALVARADO ESCOTO, ROANOKE, TX (US)

(72) Inventor: Ricardo Daniel ALVARADO ESCOTO, ROANOKE, TX (US)

(21) Appl. No.: 14/746,897

(22) Filed: Jun. 23, 2015

(51) Int. Cl. F02B 71/04; F02B 35/00; F02B 75/02; F04C 14/24; F02D 15/04; F02D 41/26; F03C 2/30; F02B 3/02; F02F 1/18

(52) U.S. Cl. CPC F02B 71/04; F02B 3/02; F02B 35/00; F02B 75/02; F02F 1/183; F02D 15/04; F02D 41/263; F03C 2/304; F04C 14/24; F02B 2075/025

(57) ABSTRACT

A highly efficient two-stroke internal combustion engine with free pistons and a simple torquing vane device instead of a crankshaft is provided. Inside the motor, hydraulic oil is used to transmit power from the piston to the torquing vane device. The engine must have at least two cylinders. The cylinders have a special shape to allow the use of valves for a continuous production of torque and power. The use of solenoids and an electronic control unit coupled with a microprocessor are given to this invention a series of advantages that a regular engine available in the open market does not have. This engine produces high torque and is suitable for any duty use. The use of hydraulic oil will guaranty a smooth, fluent and quiet operation, lubricating and protecting all components inside the motor and a total distribution of temperature along all mechanisms thus a long life.

### GLOSSARY OF TERMS

ACTUATORS: Are devices which move a pin back and forth using electromagnetic, pneumatic, hydraulic or mechanical force.
BDC: Below Dead Center, Piston located in the lower portion of the cylinder with crankshaft at 180 degrees position.
CAMLESS: Motor not using cams and springs on top, to control the puppets valves.
COMPRESSION-RATIO: Is the relation between volumes. piston displacement+volume combustion chamber: volume combustion chamber.
CYCLES: One cycle is equal to four strokes in a four-stroke motor, or a cycle is equal to a two strokes in a two-stroke motor.
DIAPHRAGM: A device that can be compressed at peak pressure and return to their original state when the pressure subsides.
ECU: Electronic Control Unit, just coordinate and control the solenoids in an engine, and it could have a microprocessor adapted or not.

### EMBODIMENTS

There are only two embodiments, the main embodiment which will be call simply the embodiment and the alternate embodiment which will be referred like that in the entire document.
ENGINE: The motor plus all the auxiliary components to make it function i.e. battery, fuel tank, fan, air compressor, vacuum pump, gear box, etc.
FREE PISTON: A piston with no attachments, that can move freely in the circular section of the cylinder.
GLOW-PLUGS: Small electric devices screwed and protruding inside the combustion chamber to heat them.
HP: Horse Power a measure of power produced by a unit of time.
ICE: Internal Combustion Engine.
IN-LINE: To be placed one beside another forming a line.
MOTOR: The metal block which inside include: the combustion chambers, the cylinders, the torquing vane device mechanism, the pistons, etc.
Oil: In the text it refers to Hydraulic oil.
POPPET's VALVES: Are the one which on top of the motor and exactly at the combustion chambers control the intake and exhaust.
PSI: Pound per square inch, is a measure of pressure.
REGULAR: Typically or commonly used and available in the open market.
REPLENISHER: A device that constantly replenish oil to maintain a constant quantity or level inside the motor, also named constant-level oiler.
RPM: Revolutions of the crankshaft per minute.
PPM: Parts per million.
SCAVENGING: Is the process of pushing exhaust gases out of the cylinder by the cross flow of new air.
SOLENOIDS: Electromagnetic actuators.
SPARK PLUGS: Small electrical devices screwed and protruding inside the combustion chamber to ignite the fuel.
TORQUING: Action to cause torque. Device which produce torque, or a twisting motion.
TDC: Top Dead Center, when the piston is a the top of the cylinder and the crankshaft is at cero degrees.
TORQUING DEVICE: The positive displacement straight metal vane pump adapted for torquing purposes.
VANE: A flat rectangular metal plate, radially inserted in the drum of the torquing device.

### FIELD OF THE INVENTION

The present invention relates to an engine to produce torque and power using a combination of an internal combustion motor, hydraulic oil as a medium to transmit power and a vane device U.S. Pat. No. 7,425,121B2, adapted to produce torque in the most efficient manner. It follows under US class 123 Internal Combustion Engine.

### BACKGROUND OF THE INVENTION

Currently, due to the severity of world-wide air pollution by the fume produced by the internal combustion engines all over the world, more strict emission controls are being enacted and enforced, and it is expected that in the near future the regulation requirements for emissions will become even more severe.

The latest atmospheric measurements for air pollution at Mauna Loa Observatory is about 399 PPM, and according to the International Energy Agency (IEA), in 2008 the total energy used by the world 82% correspond to fossil fuel, 5.5% to nuclear and 12.5% to renewable.

Time is running out if the world wants to avoid potentially catastrophic climate change according to the most definitive report to date by the Intergovernmental Panel and Climate Change (IPCC) which is the UN body charged with formulating expert advice for governments around the globe. In the report gives a final warning about the dangers of not doing enough to curb emissions of greenhouse gases.

Even though more sources of oil are available today and that the efficiency of the motors has increased, the word-wide demand for energy is growing faster, almost exponentially. The invention proposed will help to save energy and reduce pollution for at least 40 percent minimum in what fossil fuel is concerned.

The internal combustion engine (ICE) was invented centuries ago and its developments started on the eighteen century with Etienne Lenoir in France. Throughout decades the motor industry has made several innovation and improvements to the ICE, the main drawback is the use of the crankshaft and the connecting rods to transfer the energy produced by the combustion chamber through the piston. All the major advances made so far are mostly related to the combustion chamber in that the power stroke is concern, also some auxiliary systems around have been improved like the electrical system, the gearbox, the lubricating oil, turbo devises, Etc.

Some new ICE designs have appeared throughout the years like the Wankel Rotary Motor, Ecomotors, Stirling, Scudery, Toyota reciprocating FPEG motor, the CCEFP free piston engine, the Harold Caminez Internal Combustion Engine U.S. Pat. No. 1,714,847, the Web disk generator, The Fijalkowski engine, etc. and others, all of them offer good solutions under some special circumstances and due to their high cost of production, complexity, unsolved problems and others limitations they are not yet fully and widely use.

The regular internal combustion engine used now-a-days, either in cars, trucks, generators, or in any form are extremely inefficient, under real circumstances the transformation of the chemical energy in the fuel into useful mechanical energy is around 21 percent in gasoline motors and about 34 percent in the diesel. Note that one gallon of Diesel has 147,000 British Thermal Units (BTU) while the gasoline only has 125,000. Almost all this energy is dissipated in the atmosphere in a form of heat.

### DESCRIPTION OF PREVIEWS RELATED ART

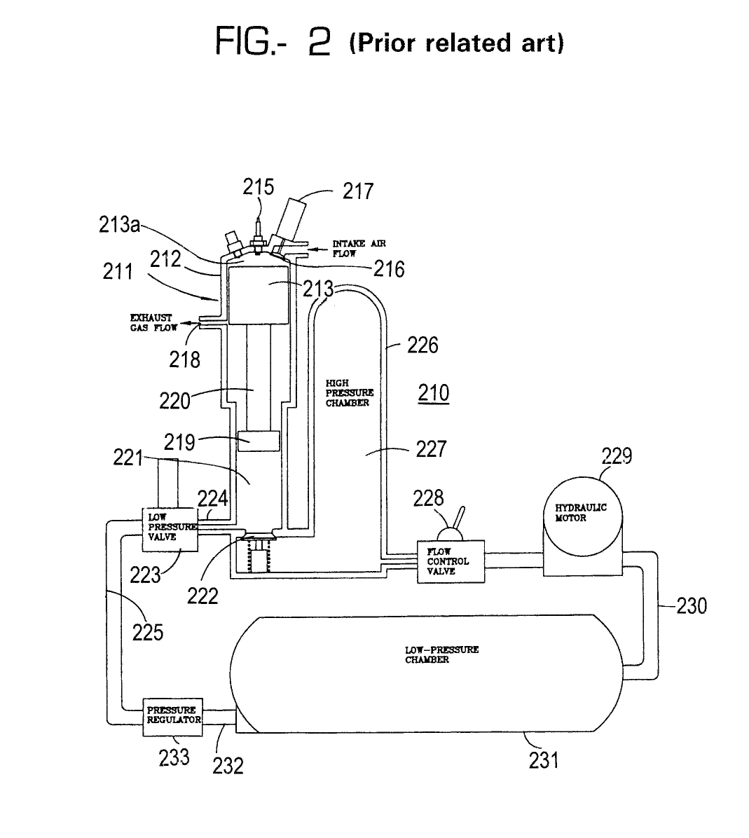

A prior related art is found, U.S. Pat. No. 6,551,076 dated Dec. 15, 2000 by Jim L. Boulware, with the title of: Fuel/Hydraulic engine system. A drawing of this invention is presented in FIG. 2. Even though the process of operation is similar to our invention this systems is more gear to produce energy as stationary generators, as it comprises of various tanks and is bulky and heavy in nature.

One notable difference it is in the combustion mechanism which it uses a regular one cylinder, two-stroke engine. But this type of system can also use an electric motor.

This related art has being used for decades in the industry especially in manufacturing plants all over the world and is being used with oil or with air, with one or several hydraulic/pneumatic motors located in different places in series.

Summing up, the other big differences against our invention consists in the arrangement of components, the bulky nature of the system, the cylinder shape, the use of a piston shaft to push oil, to produce pressure and use it with an exterior hydraulic motor, this against the total merge of the torquing device inside the motor using oil as a medium to transmit power directly from the piston toward a vane torquing device with guides. Also, concerning the especial check-in and out valves, our invention cannot use less than two cylinders and is meant to be fitted even under the hood of a regular contractor pick-up truck.

### TITLE OF THE DRAWINGS

### Front Figure, Front View.

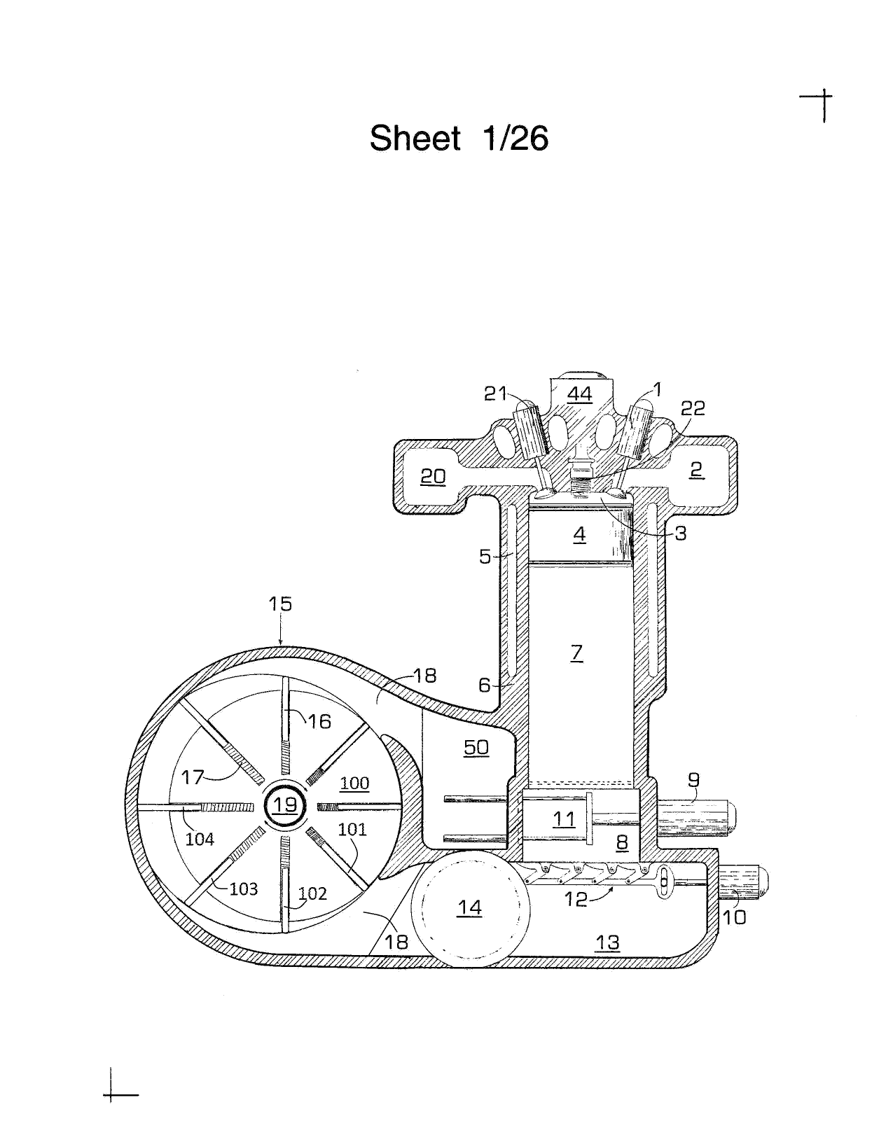

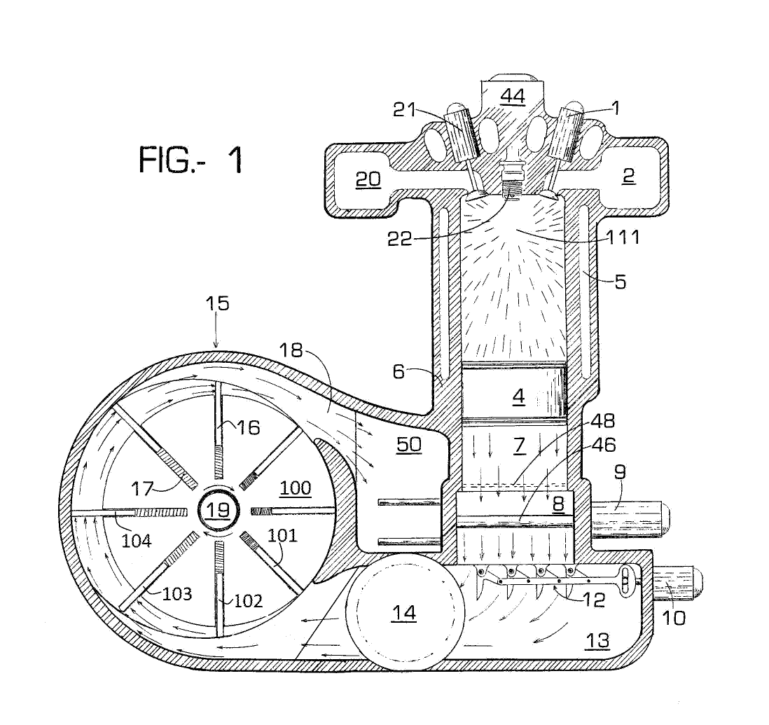

FIG. 1 MAIN EMBODIMENT IN ACTION.

FIG. 2 PRIOR RELATED ART.

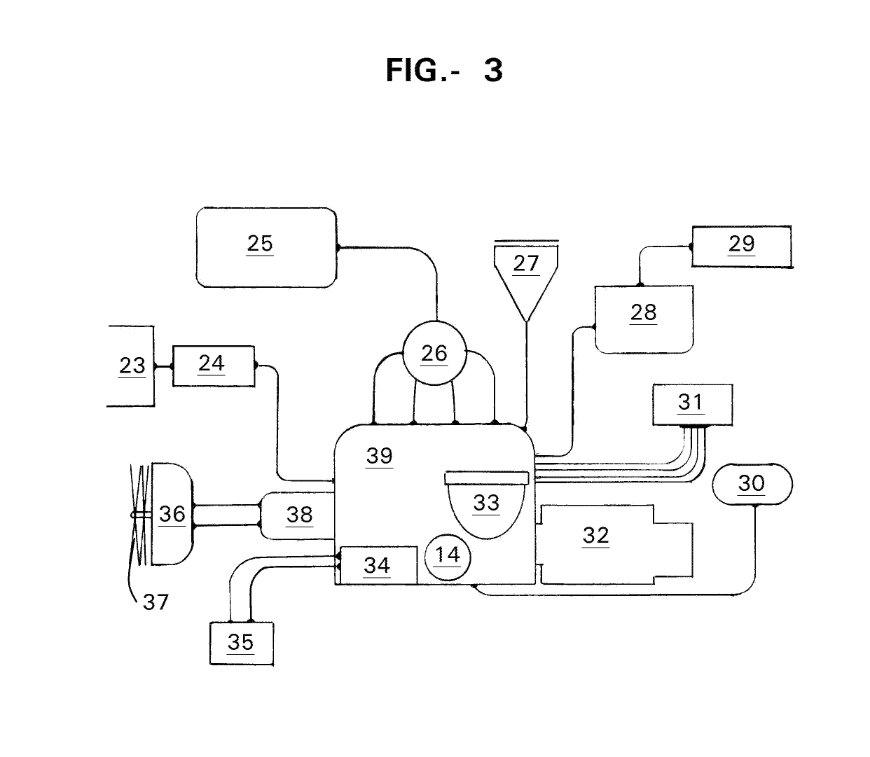

FIG. 3 ENGINE'S MAIN COMPONENTS.

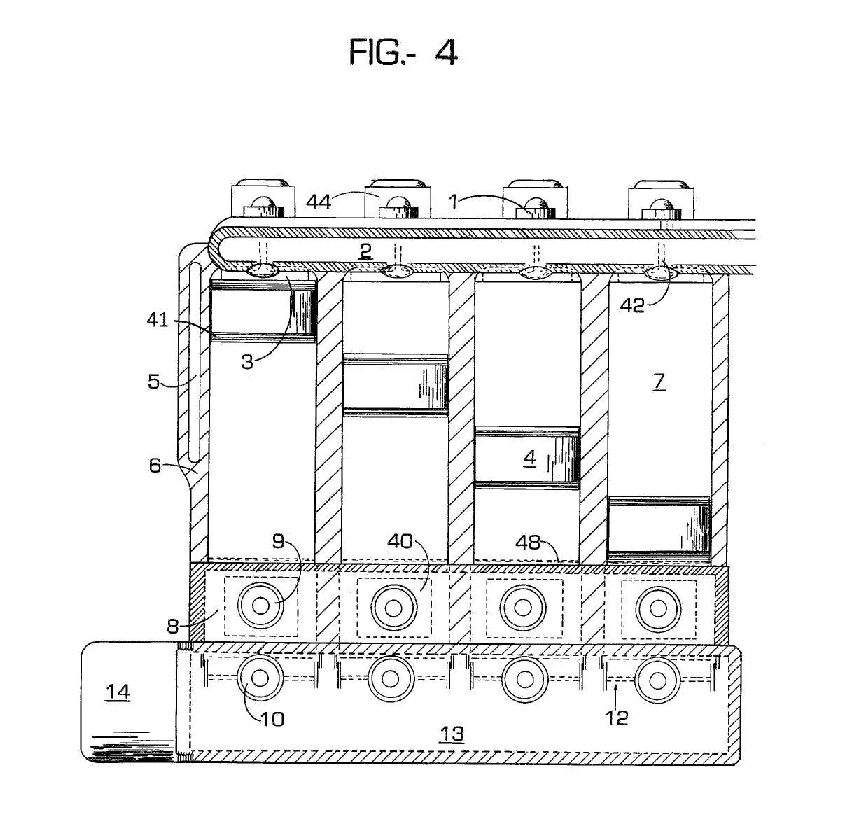

FIG. 4 SIDE VIEW.

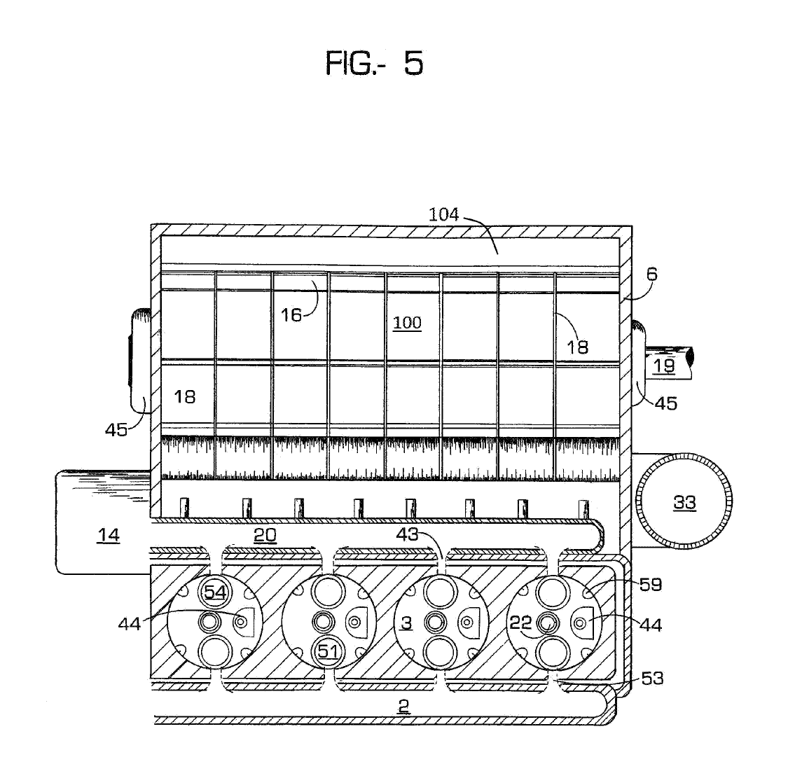

FIG. 5 UPPER VIEW.

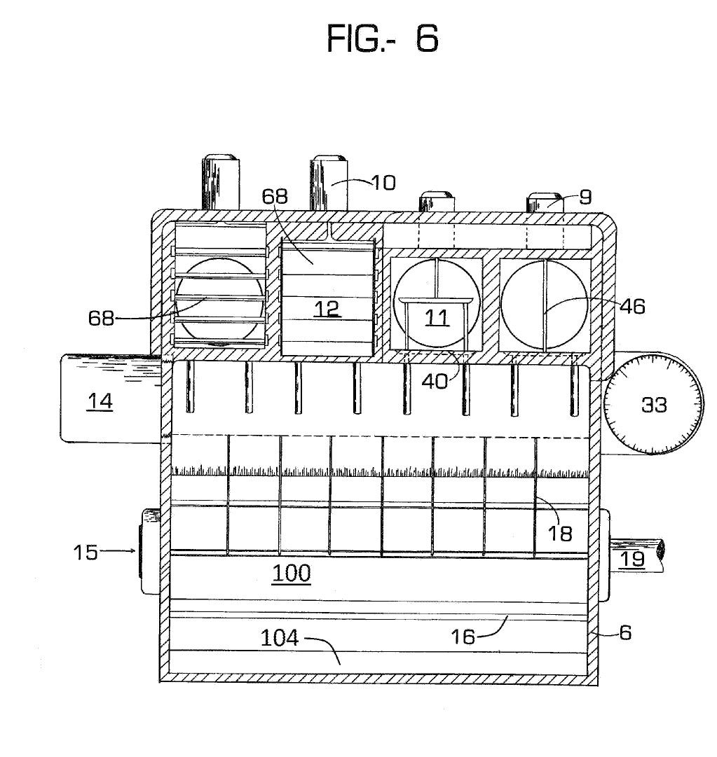

FIG. 6 LOWER VIEW.

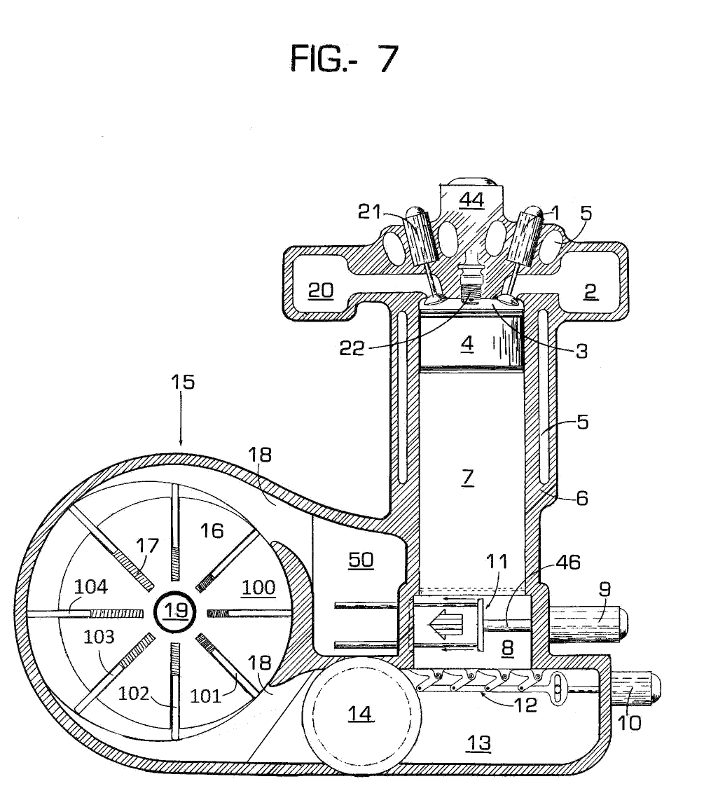

FIG. 7 PISTON AT TDC POSITION.

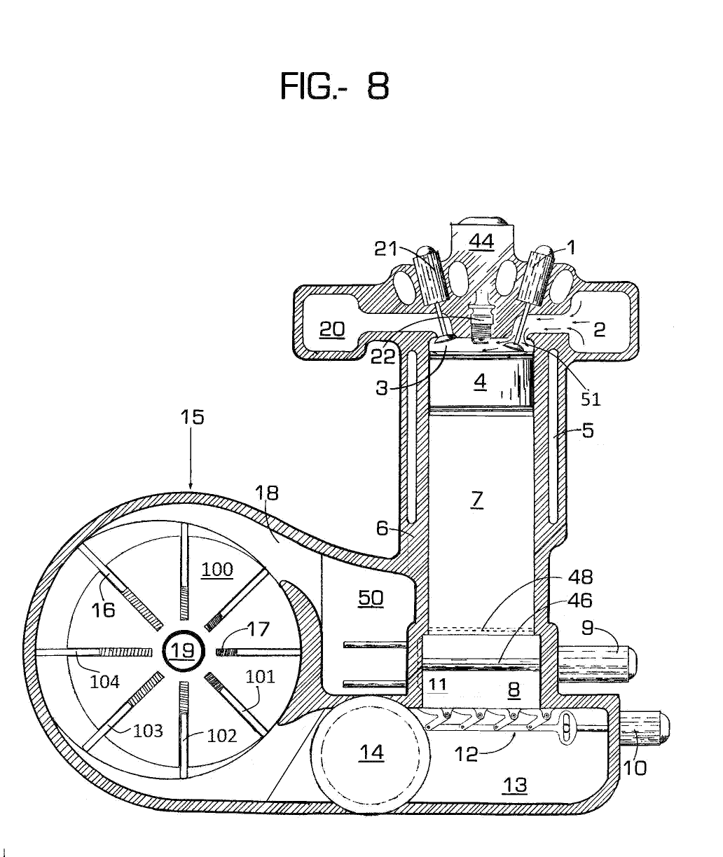

FIG. 8 FUEL-AIR-INTAKE (STARTING POINT).

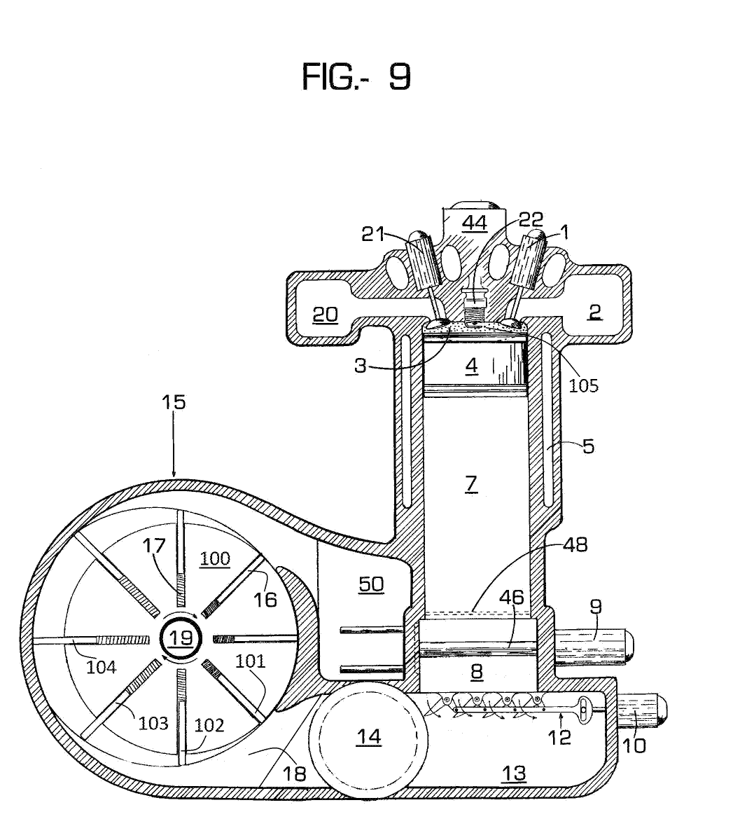

FIG. 9 PISTON GETTING READY FOR POWER STROKE.

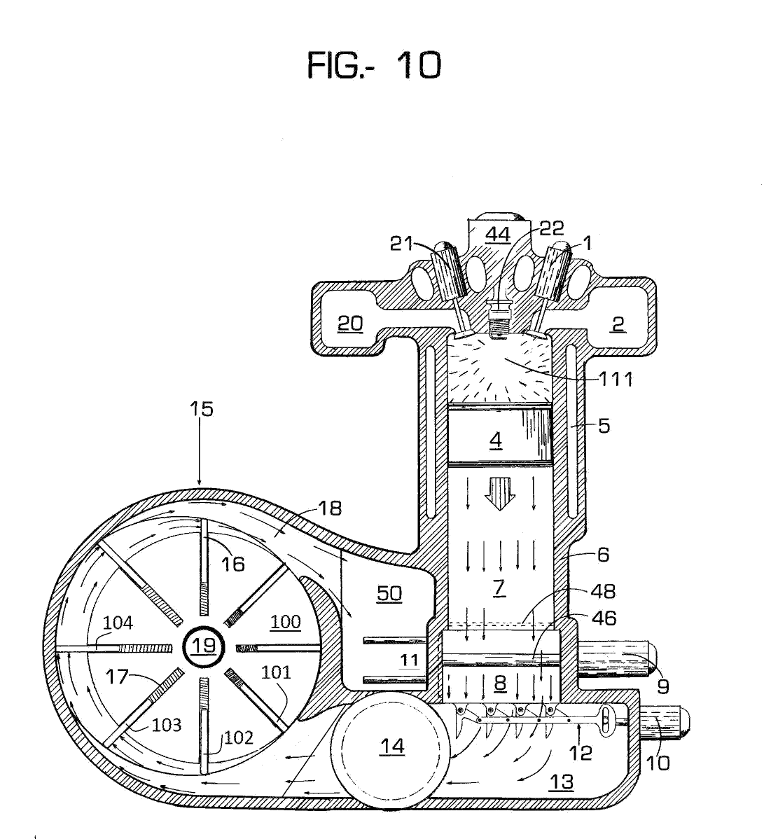

FIG. 10 POWER STROKE, EXPANSION, PISTONG GOING DOWN.

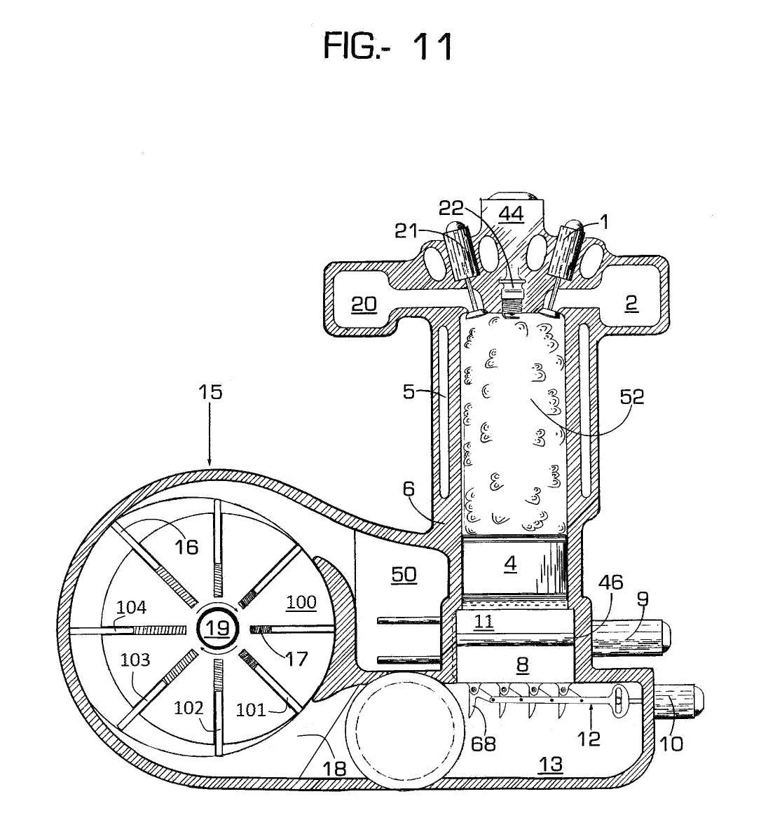

FIG. 11 PISTON ARRIVING AT BELOW DEAD CENTER (BDC).

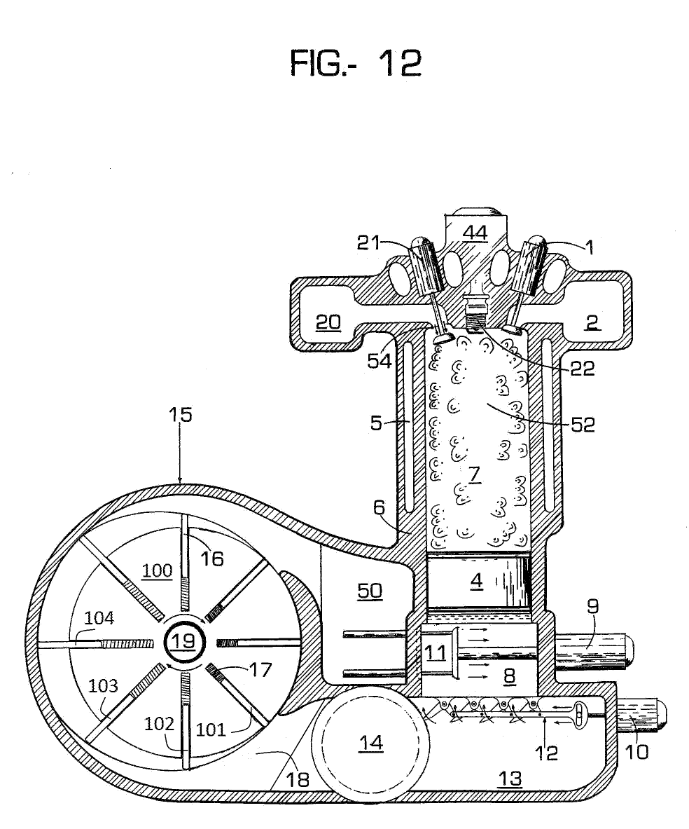

FIG. 12 PISTON AT (BDC) POSITION, GETTING READY FOR EXHAUST.

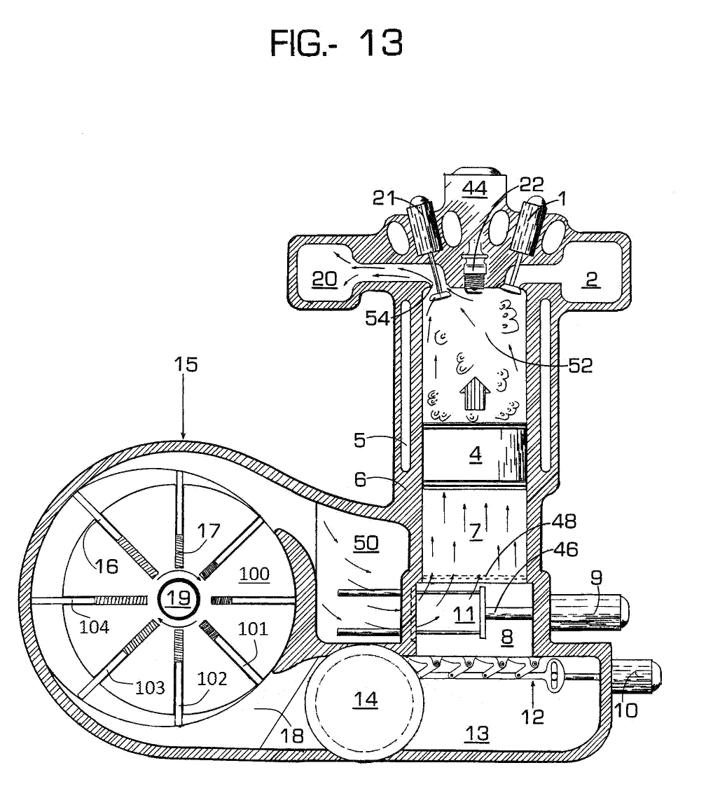

FIG. 13 PISTON GOING UP, EXHAUST STROKE.

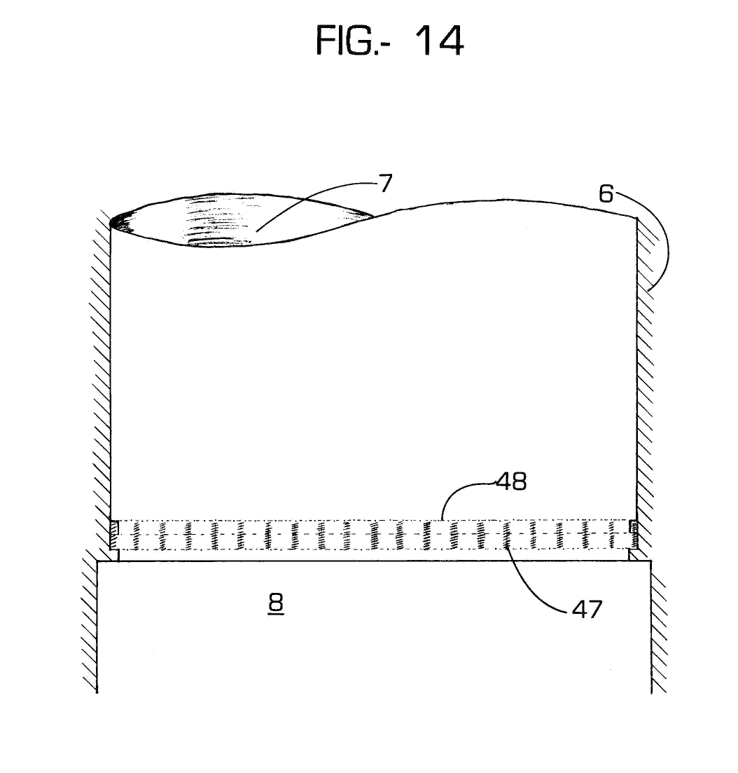

FIG. 14 ATTENUATOR VIEW IN THE CYLINDER.

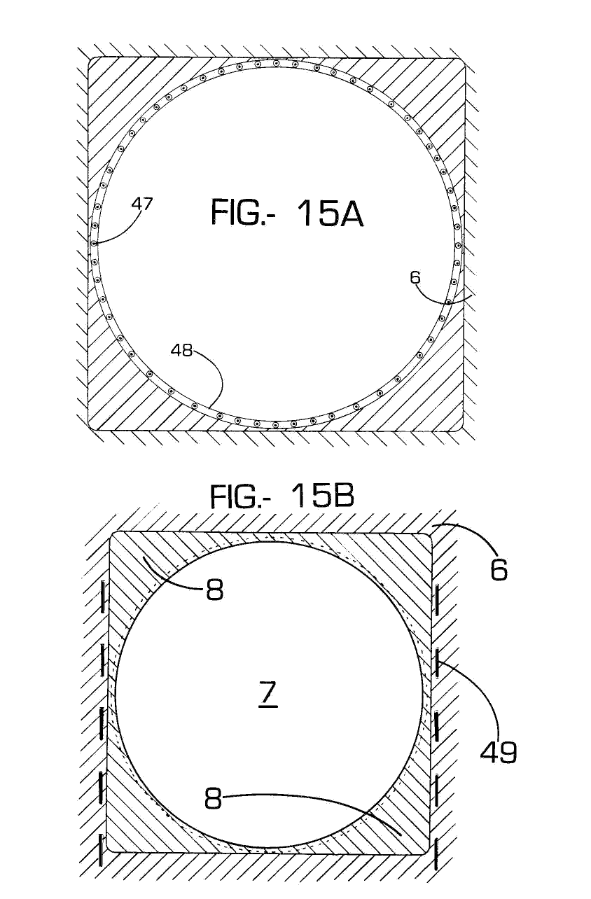

FIGS. 15A and 15B MORE CYLINDERS'S NOICE ATTENUATOR VIEWS.

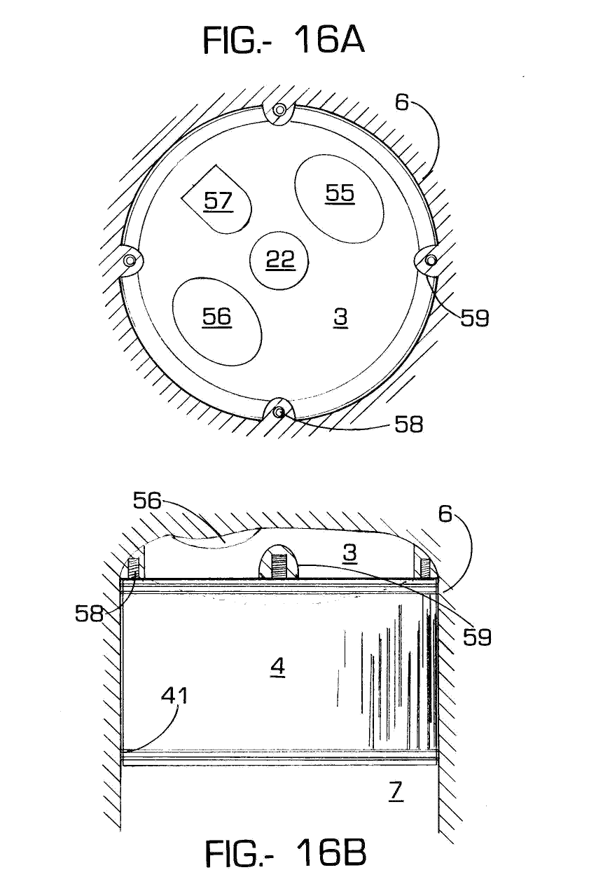

FIGS. 16A and 16B COMBUSTION CHAMBER'S VIEW.

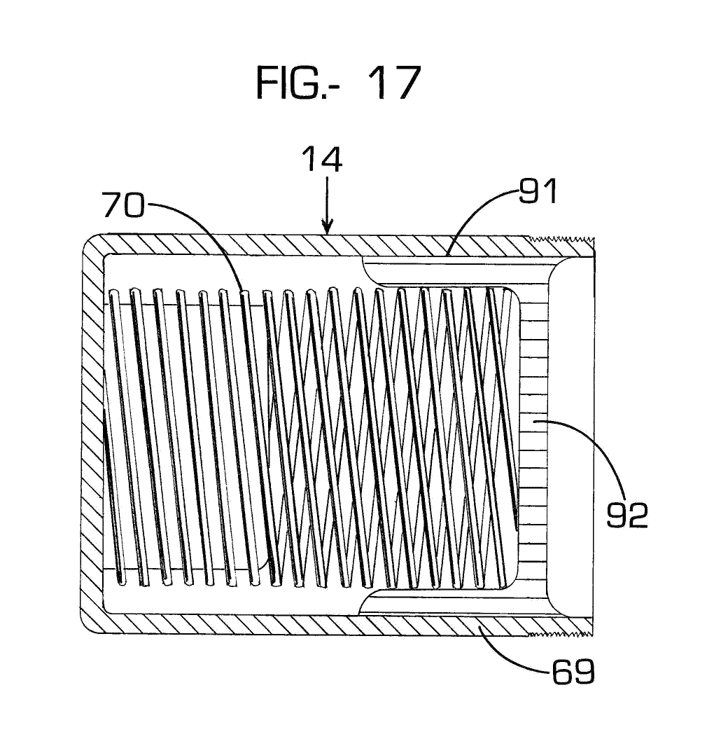

FIG. 17 DIAPHRAGM VIEW.

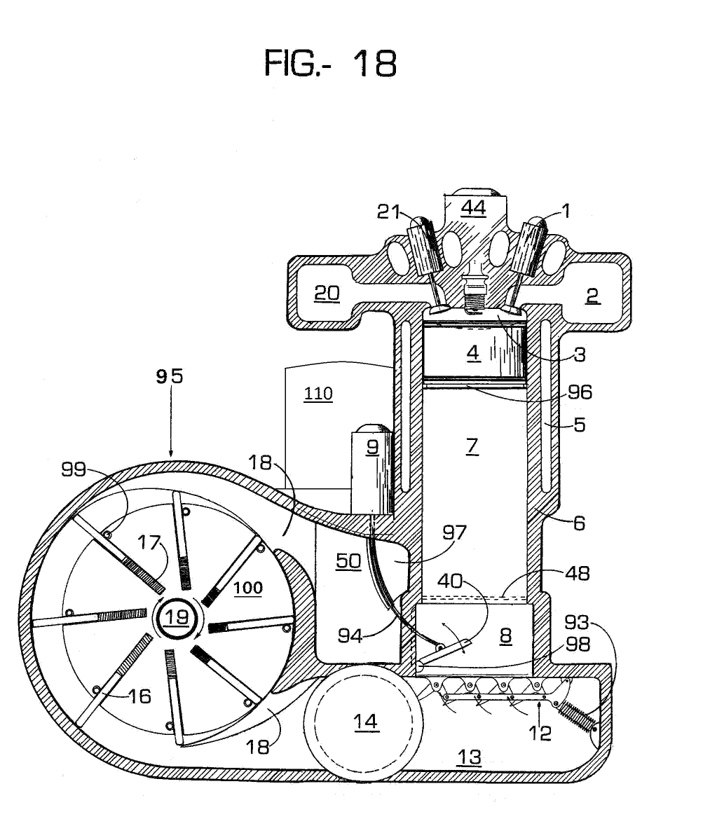

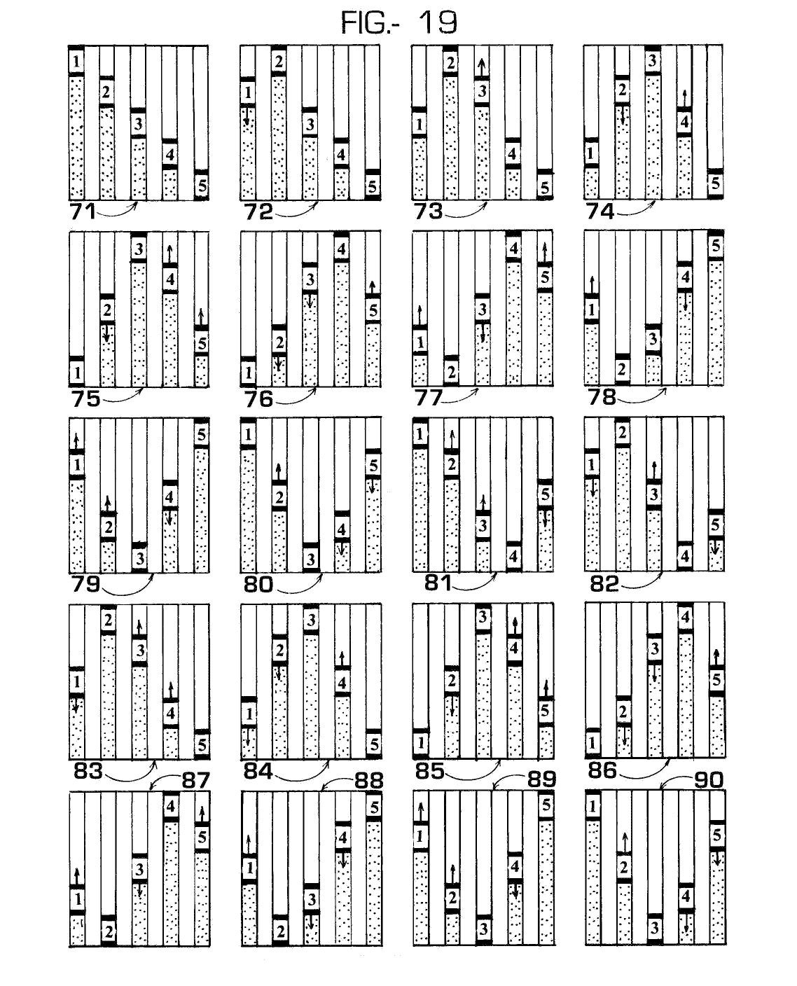

FIG. 18 ALTERNATE EMBODIMENT.

FIG. 19 MOTOR MODE OF OPERATION (FIVE CYLINDERS).

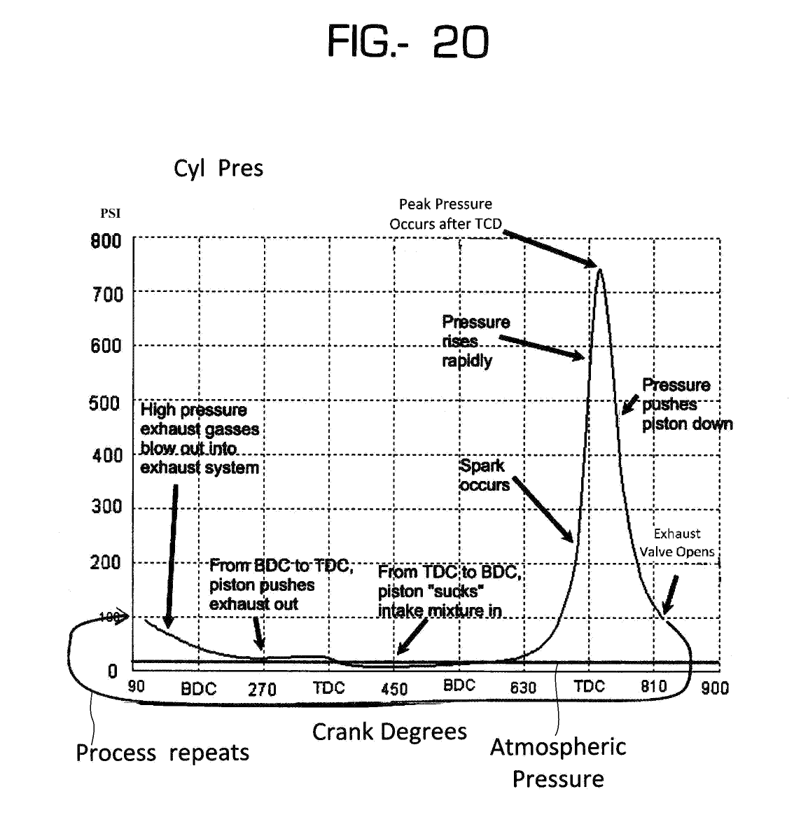

FIG. 20 GASOLINE COMBUSTION STROKE, IN-CYLINDER PRESSURE PROFILE.

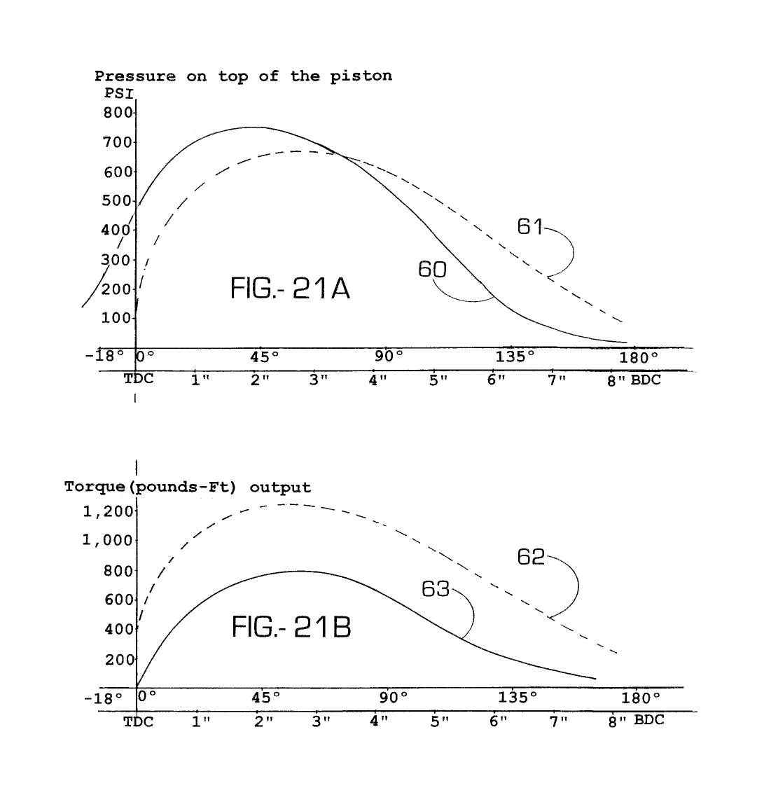

FIGS. 21A and 21B GASOLINE PRESSURE AND TORQUE OUTPUT GRAPHICS COMPARISON.

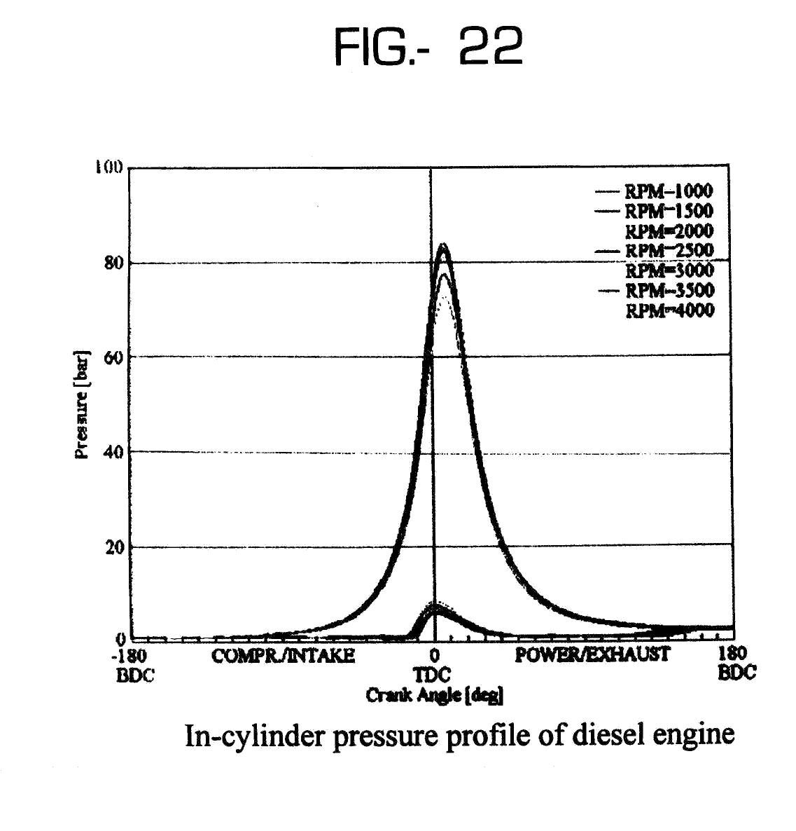

FIG. 22 DIESEL COMBUSTION STROKE, IN-CYLINDER PRESSURE PROFILE.

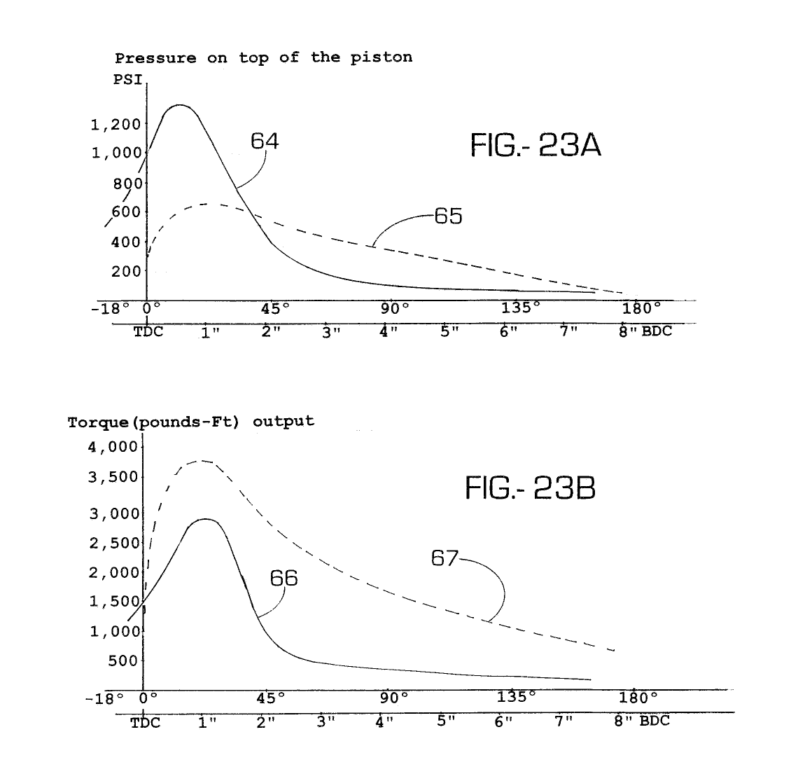

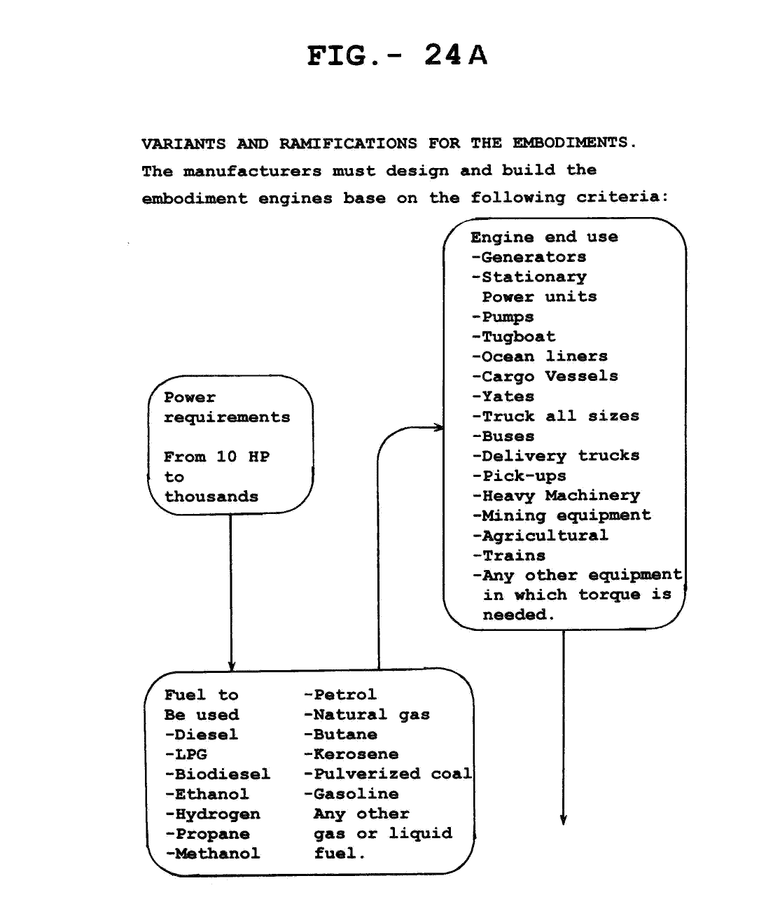

FIGS. 23A and 23B DIESEL PRESSURE AND TORQUE OUTPUT GRAPHICS COMPARISON.

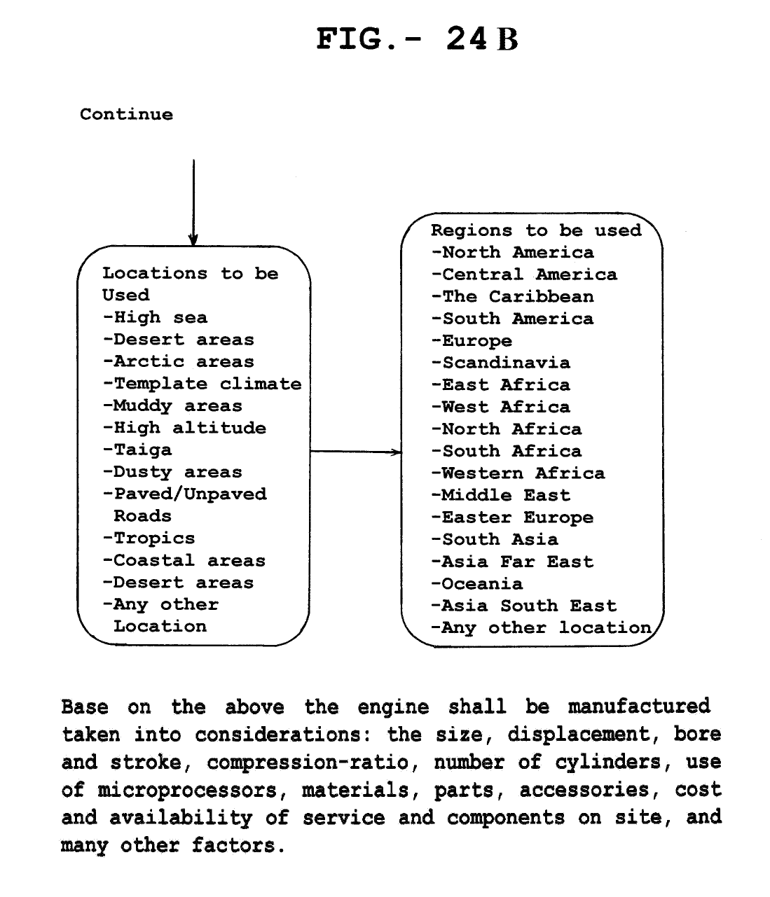

FIGS. 24A and 24B DESIGN, RAMIFICATION AND MANUFACTURING VARIANCES.

### BRIEF DESCRIPTION OF THE SEVERAL VIEWS OF THE DRAWINGS

FRONT FIGURE.—Is a longitudinal frontal view of the main embodiment.

FIG. 1 Is a longitudinal view of the main embodiment in action during the combustion stroke.

FIG. 2 Is one of the main drawing of a related prior-related-art mechanism.

FIG. 3 It shows all the main auxiliary components of the engine.

FIG. 4 Is a longitudinal side view of a four cylinders motor with the pistons in different positions.

FIG. 5 Is a longitudinal view of a four cylinders embodiment as seen from the top.

FIG. 6 Is a longitudinal view of a four cylinders embodiment as seen from below.

FIG. 7 Is a longitudinal view of the front of the embodiment with the piston at TDC position.

FIG. 8 Is a longitudinal frontal view of the embodiment when air and fuel enter the combustion chamber.

FIG. 9 It show the combustion chamber and the valves getting ready for power stroke.

FIG. 10 Is a longitudinal frontal section of the motor in action during power stroke.

FIG. 11 Is a longitudinal frontal view of the piston arriving at BDC position.

FIG. 12 Is a longitudinal frontal view of the embodiment getting ready for the exhaust stroke.

FIG. 13 Is a longitudinal frontal view of the exhaust stroke.

FIG. 14 Is a side view of a noise attenuator in the lower circular portion of the cylinder.

FIGS. 15A and 15B Is a longitudinal top and lower view of the noise attenuator in the cylinder.

FIGS. 16A and 16B Is a longitudinal upper and frontal view of the combustion chamber and its noise attenuators.

FIG. 17 Is a longitudinal side view of the diaphragm.

FIG. 18 Is a longitudinal front view of an alternate embodiment.

FIG. 19 It depict the different positions of the pistons in a five cylinders embodiment during its functioning.

FIG. 20 Is a graphical view of generated pressure in the combustion chamber against the crankshaft position generated during a 4-stroke gasoline cycle.

FIGS. 21A and 21B They are graphical comparison between the performance of a regular gasoline motor and the proposed invention.

FIG. 22 Is a graphical view of generated pressure in the combustion chamber, against the crankshaft position generated during a 4-stroke diesel cycle.

FIGS. 23A and 23B They are graphical comparison between the performance of a regular diesel motor and the proposed invention.

FIGS. 24A and 24B Is a diagram which list the different engine variances that can be produced using the proposed engine concept.

### REFERENCE NUMERALS FOR THE DRAWINGS

Item.-1 Solenoid activated by the electronic control unit ECU 31 to allow air at a high pressure to come inside the combustion chamber 3.
Item.-2 It is a high compressed common rail air pipe which have access to the combustion chambers through the puppet gates being open and closed by item 1.
Item.-3 It is the combustion chamber in which the power stroke take place after air and fuel is ignited. It can change the form depending on the fuel being used.
Item.-4 It is the free piston.
item.-5 It represent the water cooling passages in the motor.
Item.-6 Indicate the metal block of the motor.
Item.-7 It is the round portion of the cylinder.
Item.-8 It refer to the square lowest portion of the cylinder.
Item.-9 Solenoid controlling the check-in valve 11.
Item.-10 Solenoid which control the opening and closing of the blind-type check-out-valve just at the lowest portion of the cylinder.
Item.-11 It is the check-in-valve mechanism, includes the gate and the handling bars.
Item.-12 Indicates the blind check-out-valve mechanism.
Item.-13 Indicate the high pressure chamber in which the oil pushed by the piston at the power stroke is going to concentrate before moving to the vane type device. It is open to the other cylinders.
Item.-14 It is a diaphragm which is strategically located between item 13 and the torquing device 15, its function is to absorb the high pressure spikes and provide a smooth functioning for the motor.
Item.-15 Indicate the whole vane type torquing device.
Item.-16 Indicate the metal vanes, which receive the oil at high pressure and make the drum rotate.
Item.-17 Are small spring located underneath the vanes.
Item.-18 Are the metal plate guides around the drum 100, which push inside the vanes while they rotate, making the functioning of the torquing device with a efficiency of almost one hundred percent.
Item.-19 It is the shaft of the drum and the one which transmit the torque to the gear box.
Item.-20 Indicate the vacuum common rail pipe which collect the exhaust gases from the combustion chamber
Item.-21 It is a solenoid and its job is to open and close the exhaust poppet gate at the combustion chamber.
Item.-22 It is the spark plug who make the combination of air and fuel combust.
Item.-23 Represent the fuel tank.
Item.-24 Represent the high pressure fuel pump for the fuel common rail.
Item.-25 It is the air filter for the air-compressor.
Item.-26 Air compressor which can be of any type. It compress the air to a desired pressure depending on the type of fuel being used and has direct access to the combustion chamber through the aspiration passage item 53.
Item.-27 It is an oil replenisher (constant-level oiler) as small quantities the oil inside the motor get consumed in the cylinder during the power stroke, and the amount of oil inside the motor must remain constant at all time.
Item.-28 Is a vacuum system which is connected directly to the exhaust gate and is responsible for a quick soaking and disposal of the fumes.
Item.-29 Represent the exhaust pipe.
Item.-30 Represent the motor's fuse, which is connected to the high pressure oil chamber in case the pressure over exceed the pressure set by the manufacturer.
Item.-31 Is the Electronic Control Unit (ECU).
Item.-32 Represent the gear box.
Item.-33 Represent the hydraulic oil filter
Item.-34 It is the starter alternator.
Item.-35 Represent the battery
Item.-36 Represent the radiator
Item.-37 Represent the ventilator fans.
Item.-38 Represent the cooling system.
Item.-39 It is the motor itself.
Item.-40 Represent the gate belonging to the check-in valve.
Item.-41 Indicate the sealing of the piston consisting in compression rings.
Item.-42 Indicate the poppet valve gate for the air to enter the combustion chamber.
Item.-43 Are the passages used by the vacuum system to get the smoke out after the combustion.
Item.-44 Indicate a fuel injector for the combustion chamber.
Item.-45 Show the special ball bearing located in the axle of the torquing drum 100.
Item.-46 It is a slim metal stick connecting the check-in gate 40 with the solenoid 9.
Item.-47 Small springs, they support the metal ring 48 about 1-5 millimeters above the edge of the cylinder 7.
Item.-48 It is the metal ring attenuator in the lower portion of the cylinder 7.
Item.-49 Indicate a protruding metal flanges or fins which support the check-out metal blind's valve 12.
Item.-50 It is the open low-pressure oil chamber in the motor. It is open to the other cylinders.
Item.-51 Poppet valve, open the passage for the fresh compressed air to go inside the combustion chamber.
Item.-52 Indicate the cylinder full of gases from the combustion.
Item.-53 Indicate the passage for the fresh air to go from the high pressure common rail 2 to the combustion chamber.
Item.-54 The poppet valve which control the exit of the gases to the vacuum common rail pipe 20.
Item.-55 It is the hole for the poppet valve 54 handling the exhaust.
Item.-56 It is the hole for the poppet valve 51 handling the air intake.
Item.-57 Is the hole for the fuel injector 44, at the Combustion chamber 3.
Item.-58 Indicate the small springs at the attenuators in the combustion chamber lugs 59.
Item.-59 Indicate the lugs attenuators in the combustion Chamber 3, they protrude from the motor block 6 having a small spring inside 58.
Item.-60 Indicate the pressure in PSI during the power stroke in a regular gasoline motor and its evolution during the crankshaft movement from 0 degrees (TDC) to 180 degrees (BDC), base on graphic FIG. 20.
Item.-61 Show the pressure in the combustion chamber of the invented motor, base on graphic FIG. 20. The power released in the combustion in both cases is exactly the same.
Item.-62 Graphic torque-produced/piston-displacement in the invented motor.
Item.-63 Graphic torque-produced/crankshaft-angle produced by a regular gasoline motor.
Item.-64 Graphic indicating the pressure in PSI on top of the Piston 4 during the power stroke in a regular diesel motor and its evolution during the crankshaft movement from 0 degrees (or TDC) to 180 degrees (or BDC), base on the graphic provide in FIG. 22.
Item.-65 Graphic that shows the pressure generated on top of the piston of the invented motor, base on the graphic of FIG. 22. In both cases the energy released are the same.
Item.-66 Torque-produced/crankshaft-angle graphic produced by a regular diesel motor base on item 64.
Item.-67 Torque-Produced/piston-displacement graphic produced by the invented motor due to the pressure produced by item 65.
Item.-68 Steel blinds belonging to the check-out valve open and closed to better illustrate, and how they connect with the solenoid 10.
Item.-69 Is the diaphragm metal carcass.
Item.-70 Is the spring inside the diaphragm.
Item.-71-90 Items from 71 up to item 90 shows the position of the pistons numbered from 1 to 5, in their respective cylinders due to a programmed ECU 31 sequence in a 5 cylinders motor.
Item.-91 Show the total seal between the moving piston and the block of the diaphragm.
Item.-92 Is the diaphragm's moving piston.
Item.-93 In the alternate embodiment, it indicate the springs that close the check-out valve mechanism 12.
Item.-94 In the alternate embodiment, FIG. 18, It is the filament that ensure the closing and opening of the check-in gate.
Item.-95 Represent an eccentric torquing vane device.
Item.-96 Indicate a noise attenuator located in the lower side of the piston 4.
Item.-97 In the alternate embodiment FIG. 18, it is the plate that serve as a guide to the metal filament item 94.
Item.-98 Spring that closes the check-in gate 40.
Item.-99 Rollers to better slide the vanes 16, in and out.
Item.-100 Torquing drum which hold the vanes 16.
Item.-101 First working vane.
Item.-102 Second working vane.
Item.-103 Third working vane.
Item.-104 Fourth working vane.
Item.-105 Combustion Chamber full of air and fuel before the combustion stroke.
Item.-110 Diaphragm for the low-pressure chamber.
Item.-111 Represent the combustion and its expansion on top of the cylinder pushing the piston 4 down.
Item.-210 It is the fuel hydraulic system.
Item.-211 represent the fuel combustion engine.
Item.-212 It is the cylinder.
Item.-213 It is the piston.
Item.-213a Represent the combustion chamber.
Item.-215 It is the spark plug.
Item.-216 Intake Poppet valve.
Item.-217 Solenoid for the intake poppet valve 216.
Item.-218 Represent the combustion gases exhaust port.
Item.-219 Hydraulic work piston.
Item.-220 Shaft connecting the motor piston 213 with the hydraulic piston 219.
Item.-221 Work oil cylinder chamber.
Item.-222 Check-Out-Valve controlling the high pressure fluid.
Item.-223 Check-In-Valve controlling the low-pressure fluid.
Item.-224 Fluid feeder pipe.
Item.-225 Pipe from the low-pressure chamber 231 to the low pressure valve 223.
Item.-226 High pressure fluid accumulator.
Item.-227 High pressure chamber.
Item.-228 Flow control valve.
Item.-229 Hydraulic motor.
Item.-230 Pipe
Item.-231 Low-pressure chamber accumulator.
Item.-232 Pipe.
Item.-233 Pressure regulator.

### DETAILED DESCRIPTION OF THE DRAWINGS

### Front Figure, Front View.

In this figure the embodiment is shown with the vane torquing device totally integrated with the internal combustion mechanism and it can be seen the way and how they are interconnected. The components indicated are from 1 to 22, and at the top as fuel injector mechanism for the combustion chamber, plus item 100 which represent the torquing drum and the working vanes 101 to 104 totally integrated to the drum 100. Items 7, 8, 13, 15 and 50 are totally filled with oil.

### FIG. 1

### Embodiment in Action

This drawing provides an idea on how this invention works. In the drawings, a gasoline combustion engine is presented, but the invention can be designed and manufactured to work with any type of fossil fuel. In this particular figure item 111 indicate the combustion which push the piston 4 and the oil down making the oil to push the vanes 16 therefore producing rotation with tremendous torque.

### FIG. 2 Previews Related Art

This art U.S. Pat. No. 6,551,076 is presented with items from 210 to 233. The process of operation is similar to our invention with a total different arrangement, using a regular two-stroke combustion engine 211 and a shaft 220 which connect the piston 213 of the engine to the cylinder oil chamber 221.

### FIG. 3 Main Components of the Engine

Even though this is a two-stroke motor, in order to produce enough cycles per minute to be commercially viable it need to have incorporated an air compressor 26 US20120285415A1, which can be any type, and driven by the motor, the pressure to be produced depend on the type of fuel being used, and a vacuum system 28, which is connected directly to the exhaust gate and is responsible for a quick soaking and disposal of the fumes ensuring fresh air to the combustion chamber.

Aside for the above two items which are directly related to the speed, a diaphragm 14 is included and this can be any type available in the market as long as withstand the pressures in the high pressure chamber which under working conditions may be between 100 to 200 PSI, the purpose of the diaphragm is to provide a smooth operation inside the motor softening or absorbing high pressure spikes.

An oil replenisher 27 is included as the oil inside the motor lubricates the walls of the cylinders and therefore gets consumed in the cylinder during the power stroke. At all time the amount of oil inside the motor must remain the same.

A fuse 30 is included it can be located in the high pressure chamber or in any other location and its function is to prevent damage to any mechanism connected to the motor and to the motor itself in case a high pressure of torque spike occurrence.

The filter 33 is included, as the engine contain a lot of hydraulic oil inside and due to its functioning the oil get dirty, therefore it need to be continuously filtered, it is suggested a disposable filter to be easily changed regularly to provide clean oil for the operation. The oil inside the motor must be changed from time to time as indicated by the manufacturer, but the regular changing of filters will enlarge the life of the oil as well as the motor.

The rest of the items indicated are well-known in the motor industry. Fuel tank 23, Fuel high pressure pump 24 to provide fuel to the injectors. Cooling fan 37. Radiator 36. cooling system 38. The battery 35. The starter 34. The air filter 25 for the air compressor 26. The exhaust pipe assembly 29. The gear box 32. The engine itself 39.

Concerning, the Electronic Control Unit 31, this is an electronic unit we have included, which coordinate all the solenoid activities connected to the poppet valves 1 and 21, the fuel injector 44 and the check-in 11 and out 12 valves and make sure they act in the right sequence as establish by the manufacturer.

### FIG. 4 Side View

This view shows a four cylinders embodiment with the pistons in different positions. When the motor is turned off they will maintain their position as the amount of oil inside the motor does not change and the torquing device mechanism 15 does not move. When the motor start then the power stroke in the first cylinder will take place and all the components will start acting back again. In this figure we present gate 40 belonging to the door of the check-in valve 11. The metal rings sealing 41 of the pistons 4 consisting in compression rings. The poppet valve 42, control the entrance of the air into the combustion chamber 3.

### FIG. 5 Upper View

The upper view of the invention do not show items 1, 21, 22, 44. For better illustration shows the four cylinders and the torquing device mechanism to its side. This is the vest arrangement even though the torquing device 15 can be located in many different positions, like: below the cylinders, to the right side, at 45 degrees, etc. The motor can have from two to as many cylinders in-line as the manufacturer considers necessary. In this figure the added items that can easily be seen are the hole for the fuel injector 44, for the puppet valves 51 and 54, plus the hole for the spark-plug 22. The air passages 43 for the common rail vacuum pipe 20 connecting to each combustion chamber 3. The location of special ball bearing seals 45 located in the axle of the torquing device.

### FIG. 6 Lower View

This view illustrates two important items for this invention, a slim stick 46 connecting the check-in gate 40 with the solenoid 9, and a steel blind 68 belonging to the check-out valve 12, one is open and beside there is one closed to better illustrate their functioning and how they connect with the solenoid 10. Also we can see the filter assembly 33.

### FIG. 7 Piston at TDC Position

This figure shows the embodiment with the piston 4 on top of the cylinder 7 and getting ready to work, closing the check-in valve 11.

### FIG. 8 Fuel-Air-Intake (Starting Point)

The solenoid 1, just open the poppet valve 51, and air at a high pressure go inside the combustion chamber. At this moment check-in valve 11 and check-out 12 are closed.

### FIG. 9 Piston in TDC, Getting Ready for Power Stroke

In this Figure the solenoid 1, close the poppet valve 51, the fuel injection in the combustion chamber begins, the check-in valve 11 is closed and the check-out valve 12 is opening. Air and fuel mixture 105 are in the combustion chamber.

### FIG. 10 Power Stroke, Combustion, Piston Going Down

In this Figure, it is illustrated the power stroke in progress, the combustion take place in the combustion chamber being expanded 111, the piston 4 is going down, the oil below the piston in the cylinder 7 is pushed down with tremendous pressure, the check-in valve mechanism 11 is closed while the check-out valve 12 is fully open, allowing the oil to go to the high-pressure chamber 13 and hydraulically moving the oil to the vanes 16 of the torquing device 15 causing the drum to rotate with tremendous torque.

### FIG. 11 Piston Arriving at Below Dead Center BDC, Position

Once the piston 4 has reach the Below Dead Center (BDC) position due to the full expansion of the combustion gases 52, then the check-in valve mechanism 11 is ready to open, the check-out valve 12 is ready to close and the exhaust solenoid 21 is ready to open the poppet valve. The low-pressure chamber 50 is totally opened to the other 3 cylinders.

### FIG. 12 Piston at BDC Position, Getting Ready to Exhaust

In this Figure, the solenoid 21 open the exhaust poppet valve so the vacuum rail chamber 20 start soaking the fumes, the check-in valve 11 is opening the gate and the check-out valve 12 is closing the blinds. The exhaust stroke cannot take place unless all the items are in their respective positions.

### FIG. 13 Piston Going Up —Exhaust Stroke

The piston 4 is going up pushed by the incoming oil. The fumes 52 in the cylinder 7 there are being soaked by the vacuum through the poppet gate 54. In this position the check-in valve 11 is fully opened and the check-out valve 12 is closed preventing the oil of going back into the cylinder without passing through the torquing device. And the cycle start again in FIG. 7 with the piston in TDC position after the solenoid 21 and the check-out valve 11 close.

### FIG. 14 Cylinder View

This drawing shows only the front portion in which the cylinders turns from round to square and were the piston rest in its below dead center (BDC) position. The metal ring 48 supported by small springs 47, the ring is supported about 1 to 5 millimeters above the edge of the cylinder. In the power stroke the piston 4 moves quickly down and end hitting the ring 48 which receives the hit softly with the help of the springs, and the oil inside the groove mitigating the impact.

### FIGS. 15A and 15B Noice Attenuator Views

This is related to the FIG. 14, and it shows the same ring seen it from above FIG. 15A and below FIG. 15B. Here 49 indicate one of the metal flanges or metal fin which protrude from the motor block to support the check-out metal blinds valve 12. The most important function of the ring is to reduce the noise and the impact of the piston.

### FIGS. 16A and 16B.—Combustion Chamber Views

This shows the combustion chamber with four piston retainers 59, they protrude from the motor block having a small spring 58 inside, considering that the pistons are free in their exhaust stroke, traveling quickly upward to the combustion chamber 3, they are stopped by the springs 58 inside the lugs 59, this way avoiding to hit the block of the motor causing noise and possible cracks.

### FIG. 17 Diaphragm View

This is a type of diaphragm to be used in the invention, this type is screwed in the block of the motor near the high pressure chamber, this shall consist of a strong metal carcass 69, a well designed spring 70, a moving piston 92 with a total seal to the side 91. The diaphragm is selected and calibrated at factory. Here, we just illustrate one type but in the market there may be other types that can be successfully used.

### FIG. 18

### Alternate Embodiment

The alternate embodiment preserves the same arrangement as the main embodiment with different position of the solenoid 9 which use a metallic filament 94 to open and close the gate 40 of the check-in valve 11.

Another difference is the substitution of solenoid 10 for a spring 93 mechanism to operate the check-out valve 12. The piston 4 has an attenuator ring 96 built-in in the lower portion, this will even further help more to avoid the noise.

Aside, the vanes 16 of the torquing device are eccentrics, and the drum 100 has small rollers 99 to better slide the vanes in and out.

### FIG. 19 Motor Mode of Operation (Five Cylinders)

In this figure we demonstrate that the invention of a fully hydraulic internal combustion engine ICE, functioning with oil to transmit power from the free pistons to the torquing device is totally possible.

In this drawing the pistons are numbered from 1 to 5 for easy of illustration and reference only. The doted portion below the pistons represents the oil, and in each square the amount of oil remain the same.

A five cylinders engine was selected, as the pistons 4 move up and down in the cylinders 7, the amount of oil remain constant which is the most important base for this invention, the diaphragm 14 will help in the functioning too. As can be seen the pistons move up and down in a coordinated manner from frame 71 up to 90, therefore the amount of hydraulic oil inside the motor as well as the programming of the solenoids U.S. Pat. No. 4,812,690 will function as crankshaft determining the position of the piston 4 in the cylinders 7 at any given moment.

At the switch-off the pistons 4 can be programmed to end in a special position/arrangement always, and at the switch-on the engine will start in the same programmed position left. Even though we presented one mode of operation, the most important fact is that there are different modes of operation. They can be programmed using a microprocessor, the ECU and the solenoids. The solenoids can be programmed up to the one thousandth of a second.

### FIG. 20 Gasoline Combustion Stroke, in-Cylider Pressure Profile

This is a typical graphic of how the pressure in pound per square inch (PSI) is generated in the combustion chamber when the gasoline ignites. It was taken from ENGINE SIMULATIONS, Performance Trends from Livonia, Mich. a well-know source of mechanic and vehicles info, and is one company which produce software for engine simulations.

Using this graphic we will calculate and compare the torque generated in a regular gasoline motor against the present invention.

### FIGS. 21A and 21B.—Gasoline Pressure-Torque Graphics Comparison

Base on the FIG. 20 and the following engine dimensions:

Combustion chamber: 6.5 cubic inches,
Piston bore: 10 cm diameter/3.935 inches,
Piston stroke: 20.37 cm/8.017 inches,
Piston top area: 78.54 square cm/12.16 square inches,

### Compression-ratio: 15:1,

Cylinder displacement:1,600 cubic cm/97.5 cubic inches/1.6 liters. With four cylinders equals a total capacity of 6.4 liters. Base on the above dimensions, the invention is compared against a regular type engine then, it is calculated the pressure and the torque using the graphic in FIG. 21A produced by a gasoline power stroke.

The graphic 60, indicate the pressure exerted on top of the piston during the power stroke in PSI in the combustion chamber of a regular gasoline motor and its evolution during the crankshaft movement from 0 degrees (TDC) to 180 degrees (BDC).

The dotted graph 61, show the pressure exerted on top of the piston of the invented motor, as can be seen, the pressure is lower but more up-held along the stroke, and this is expected as there is not restriction on the piston posed by the connecting rod and the crankshaft. Finally the power released in the combustion in both cases is exactly the same.

In the lower graphic FIG. 21B (torque-degrees/displacement), it can be seen that the calculated torque output graphic 62 in the hydraulic motor invented is way higher than the one produced in the graphic 63 by a regular motor, again because same explanation given in the advantages, paragraphs: [0086], [0087], [0088] and [0089], the summary, and in the detailed description.

### Results:

Average torque produced by the regular motor: 481 pounds-Ft.
Average torque produced by the invention: 880 pounds-Ft.
Based on a total vane working area equal to 9 square-inches.

### FIG. 22 Diesel Combustion Stroke in-Cylinder Pressure Profile

This case is almost the same as in the gasoline stroke previously mentioned, FIG. 22 is a typical graphic of how the pressure in pound per square inch (PSI) is generated in the combustion chamber when diesel fuel ignite, and it was taken from an article named In-cylinder pressure, simulation issued by the Department of Marine Engineering and the Faculty of Mechanical Engineering at the University of Malaysia.

### FIGS. 23A and 23B Diesel Pressure-Torque Output Graphics Comparizon

Using this graphic and the same motor specs presented before in FIGS. 21A and 21B, will calculate and compare the torque generated in a regular diesel motor against the present invention. In the upper graphic FIG. 23A the thick line 64 indicate the pressure during the power stroke in PSI in the combustion chamber 3 of a regular diesel motor and its evolution during the crankshaft movement from 0 degrees TDC to 180 degrees BDC.

The dotted graph 65, show the pressure exerted on top of the piston 4 of the invented motor, as can be seen the pressure is lower but more up held along the stroke. This is expected as there is not restriction on the piston posed by the connecting rod and the crankshaft. Finally the power release in both cases is exactly the same.

In the lower graph FIG. 23B (torque-degrees/displacement), the calculated torque output graphic 67 in the hydraulic motor invented is also way higher than the one produced graphic 66 by a regular diesel motor, again because same explanation given in the advantages, paragraphs: [0086], [0087], [0088] and [0089], summary and in the detailed description.

Results:

Average torque produced by the regular diesel motor: 591 pounds-Ft.
Average torque produced by the invention: 1,599 pounds-Ft. Based on a total vane working area equal to 9 square inches.

### FIGS. 24A and 24B Design, Ramifications and Manufacturing

The design, manufacturing and use of the concept of the invented engine depend of many circumstances, some of which we have presented in FIGS. 24A and 24B. With the new technological advances in electronic and microprocessors this invention will not have any problems on satisfying many more requirements.

### Design

The invention must have a minimum of two cylinders and they must be a two-stroke engine, no scavenging process can be used, therefore must use a common rail air compressed pipe 2, the air being supplied by an air compressor 26 activated by the engine. It could also use a vacuum 20 for additional efficiency.

The torquing devise selected is a displacement metal straight vane device similar to a pump with metal guides, this is the best out of hundreds of torquing devises available. It uses metal guides around the drum to better positioning the working vanes to receive the oil pressure and make the drum turn.

The lower portion of the cylinder is square and possesses two valves which can be opened in a programmed way, allowing the flow of the hydraulic oil around.

### SUMMARY OF THE INVENTION

In trying to use hydraulic oil to be the transmitter of power in internal combustion engines the problem has been the viscosity, which limit the number of cycles per second that a cylinder is able to produce, even at 200 Fahrenheit degree operation.

To address the above problem the following solution is presented: Under the circumstances the new motor must be a two-stroke engine and use a minimum of two cylinders. After that it can use an even or uneven number like 3, 4, 5, 6, 7 or more cylinders as needed.

First. As the invention is a two-stroke engine it shall uses an air compressor 26 to supply fresh air to the combustion chamber 3, this is essential, the pressure of the air supplied may be regulated depending on the fuel type used and the demand of power.

Second. A vacuum system 20 is highly recommended but not essential. The vacuum help in soaking the combustion gases from the cylinder 7 and the chamber 3, also increase the speed of the engine. Both the vacuum pump 28 as well as the compressor 26 must be energized by the motor.

Third. The use of a 2-stroke fuel direct injection system on top 44, see U.S. Pat. No. 8,523,534, U.S. Pat. No. 8,596,246B2, U.S. Pat. No. 6,691,649B2 and U.S. Pat. No. 4,982,708A is being now used with gasoline as well as diesel.

Fourth. The flexibility in the compression-ratio (C/R), that can be used in the invention provides a tremendous justification for the efficiency.

Fifth. The use of oil will provide a total lubrication inside the motor especially to the cylinders and the vanes 16, making it more smooth and efficient.

Sixth. As the engine is totally loaded with oil, the temperature is equally distributed and therefore the engine block can be manufactured using carbon fiber reinforced U.S. Pat. No. 5,934,648A, cast ceramic U.S. Pat. No. 4,508,066A, silicon carbide fiber reinforced U.S. Pat. No. 4,341,826A, cast iron, aluminum, compacted graphite cast iron, magnesium alloy or any other light weight material.

Seventh. The pistons 4 are free in the cylinders and their movement is determined by the poppet valves in the combustion chamber 3, the combustion itself as well as by the check-in 11 and out valves 12 in the cylinders.

Eighth. In the cylinders there are some rings 48 supported by springs 47 which allow the softening of the hit and the noise produced by the piston in its way down. Aside, it has some spring mechanisms 59 in the combustion chamber 3 too, that will soften the hit of the piston 4 in its way up.

Ninth. The cylinders are circular on top 7 but square at the bottom, this will allow more hydraulic oil to circulate at the moment of the power stroke, and the most important device here is the blind type of check-out valve 12 below the cylinder, as it easily and quickly open and close allowing oil to flow from the cylinder to the pressure chamber then toward the torquing device.

Tenth. Very important is the blind type of check-out valve 12 below the cylinder, as they can rapidly and easily open and close allowing oil to flow from the cylinder to the pressure chamber, then toward the torquing device 15. The check-out 12 valve has to open and close very rapidly, otherwise the production of cycles would be very limited.

Eleventh. The Check-in valve 11 is located in the square portion 8 of the cylinder and also opens and closes rapidly, and it is located vertically in the best position to quickly accomplish its task.

Twelfth. All the power is transmitted to the working vanes 101-104 of the torquing drum 100 from the piston 4 using the hydraulic oil as a medium, during the power stroke the expansion of the gases 111 produce a tremendous pressure on top of the piston 4 and this is totally transmitted to the torquing device 15, producing torque, becoming this the most possible efficient ICE. All the valves are operated by linear electromagnetic solenoids for faster functioning.

Thirteenth. In additional to the devises mentioned above, the motor use a diaphragm 14 inside to allow peak pressures to be absorbed and create a smooth operation. As previously mentioned the motor must have a minimum of two cylinders and can go up to any number as the manufacturer may require. In case it decides to build a motor of 3, 4, 5 or more cylinders the Electronic Control Unit (ECU) JP2014019398(A) shall be programmed accordingly.

Fourteenth. The diaphragm 14 and the in-take orifice of the filter 33 are in the high-pressure chamber 13, just below the cylinder and check-out valve 12, in order to prolong the life of the hydraulic oil an oil filter 33, U.S. Pat. No. 5,182,015A, shall be easily located beside the motor and accessible to be changed every amount of time as suggested by the manufacturer.

Fifteenth. Even though in this document we included linear electromagnetic solenoids as actuators in opening and closing the valves in the combustion chambers 3 as well as in the check-in 11 and out 12 valves below the cylinder U.S. Pat. No. 6,332,446B1, the invented motor can also use cams/spring, hydraulic devices or pneumatically operated solenoids or whatever system the manufacturer select or see fit. Summing-up, the valves must open and close on time.

Sixteenth. The torquing vane device 15 is basically an straight metal vane pump, they are very common and widely used in the industry in general, and are used in diesel motors for pumping purposes. It can lift huge pressures and its efficiency is almost a hundred percent, especially using low viscosity oil.

Seventeenth. Concerning the various operations in different condition of the motor i.e. starting, shutting-off, idling, sudden demand of power, full load, etc. the Electronic control unit 31 which control all the solenoids in the combustion chamber 3, fuel injectors 44 as well as solenoids in the check-in 11 and out valves 12 of the cylinder will act as crankshaft and will control the position of the pistons 4 and their sequences.

Eighteenth. This invention uses a two-stroke motor, do not use crankshaft, connecting rods and is totally camless, instead it uses solenoids.

Nineteenth. The new technology of premixed compression ignition or the high-pressure direct fuel injection 44 to the combustion chamber can be used not only in diesel but in gasoline too or in any other type of fuel, this new technologies are now-a-day being used with great success allowing higher compression ratios and leaner mixtures. Also, in the proposed engine due to its structure the manufacturers will have more flexibility concerning the compression and the air-fuel ratio, and may use any type or mechanism of fuel delivery to the combustion chamber 3 they deem more convenient or suitable.

Twentieth. Concerning the noise, the embodiments have noise attenuators in the combustion chamber 3, and in the lower portion of the cylinder 7, they are simple but essentials. The engine itself shall be noiseless when operating under load.

This engine is recommended in heavy and medium duty use situations, the use of hydraulic oil will guaranty a smooth, fluent and quiet operations, lubricating and protecting all components inside the motor and total distribution of temperature along all mechanism, this will help especially to avoid the suddenly brutal pressures generated inside the combustion chamber in the now-a-day diesel motors.

### Operations.

In this presentation it is not mentioned the revolution per minutes (RPM) measurement when comparing the invention against the regular gasoline or diesel engine, as the invented engine presented here do not use crankshaft nor connecting rods, therefore, we use the term cycles which in the regular motor consist of four-stroke, but the invention use only two.

Concerning the mode of operation, it can use different types, we provided one in FIG. 19, but also can be used by pair of cylinders like for example: an embodiment with eight cylinders in line it can operate by pairs as two cylinders plus two cylinders plus two cylinders plus two cylinders. Having they a common torquing shaft.

The flexibility in the mode of operation is facilitated by the use of electromagnetic solenoids which can be programmed in many different ways with a microprocessor. The rule of thumb here is whenever there is a combustion stroke a check-in valve 11 must be open.

The motor can be programmed to work all weekend on a very low-speed keeping the motor and the cabin of the chauffeur warm and at the moment of start it will pick-up speed quickly.

### Advantages

The main advantage is in the efficiency on the production of torque and power per gallon of fuel than a regular motor in about 40% for gasoline and 50% for diesel, and most probable will get the same gain in efficiency using any of the rest of the available fossil fuels. The above is due to the following facts: It is proposed to use hydraulic oil to transmit the pressure from the piston to the vanes of the torquing device.

First. The start of the combustion takes place after the piston 4 reach the top dead center (TDC), against what is happening in the regular engine in which the start of the combustion take place about 15 degrees before the top dead center (TDC).

Second. The pistons 4 pressure is transmitted directly to the working vanes 101-104 of the torquing device without having to go throughout the restrictions of the connecting rods and crankshaft.

Third. The pressure produced by the combustion is fully and 100% used, unlike the regular motors which at a crankshaft angle of 135 degrees it diminishes considerably and even at 150 degrees the exhaust puppet valve just opens.

Fourth and most important is the use of linear electromagnetic solenoids which can be used due to the low-speed of the engine, therefore in this case they are fully suitable. The cycles/second or speed in each cylinder at about 200 Fahrenheit degrees at maximum efficiency can be established to be of about 7-12 (2-stroke) cycles per second per cylinder (420-720 cycles per minute), therefore in an 8 cylinders engine the total number of cycles per minute produced can be from 3,360 to about 5,760. The solenoids act in milliseconds and therefore are more efficient, and easily programmed than the mechanical cams actually used in regular motors, the advantage here is evident.

At present this solenoids are not widely use in the automotive industry because coil transient response times and saturation effects at high RPM are the big problems, which is not the case with our invention which operate at very low cycles per minute. Here the possibilities are endless.

Aside, in the proposed engine the oil lubricates all the mechanism inside and provides a smooth operation. The torque produced may double of the regular motors, it all depend of the torquing device and their vanes 16 size, the vanes which can be straight as in our main embodiment or can be eccentric to the shaft as per the alternate embodiment FIG. 18.

With the new technological advancement there is a wide range of hydraulic oils that the manufacturers can select and use base on thermal and hydrolytic stability, low chemical corrosiveness, anti-wear characteristics, long life, water rejection and viscosity.

### Disadvantages

The disadvantage of our invention is in the speed in cycles per minute, the regular 8 cylinder gasoline motor at 4,000 RPM may produce 2,000 four-stroke cycles per minute/cylinder, this is about 33 combustion strokes per second per cylinder, while a regular cylinder in a diesel engine working at 2,000 RPM may produce about 17 cycles per second per cylinder, that is to say 17 combustion strokes per second.

In this presentation, for the invention, the maximum number of combustion strokes per second per cylinder we use are 11 cycles/second per cylinder for gasoline and 9 cycles/second per cylinder in diesel, we consider that those estimations are moderate.

The benefit due to the low-speed will be in longer duration and less maintenance.

The other disadvantage concern the high consume of oil. In each cycle, a small film of oil will be left in the wall of the cylinder 7 and during the combustion that film may be consumed. The benefit of this is in the lubrication of the cylinder 7 and piston 4 hence more efficiency.

Finally, the problems of the oil seals which now a day has been solved to some degree, but this problems can be solved with a tray similar to a sump underneath the motor and from there a connection to the oil-replenisher or constant-level oiler.

### Comparative Analysis

The only way to compare the invention against a regular engine is by the number of combustions required to produce one HP. For comparison purposes will take the same motor measurements as explained in FIGS. 21A and 21B, for the embodiment and for the regular gasoline motor.

The working area is an area in the vanes 101, 102, 103 and 104 which are under oil pressure from the high pressure chamber 13, this pressure push the vanes and make the drum turn, the area depend on the maximum protrusion of the vanes and the shape of the guides. For the purposes of the comparative analysis we use 9 square inches for gasoline and for diesel.

For the embodiment:

The dimensions for the vane torquing drum are:
Diameter: 12 inches
Circumference: 37.7 inches
Length of the drum: 18 inches, working with four cylinders.
Vane 104 protrusion from the drum:
0.3125 in.×18 in.=5.625 Sq.-in. Area under oil pressure
Vane 103 protrusion from the drum:
0.25 in.×18 in.=4.5 Sq.-in. Area under oil pressure
Vane 102 protrusion from the drum:
0.1875 in.×18 in.=3.375 Sq.-in. Area under oil pressure
Vane 101 protrusion from the drum:
0.0625 in.×18 in.=1.125 Sq.-in. Area under oil pressure
Total working area: 14.625 Sq. In.

The total amount of oil to be displaced to move the drum one revolution is: 37.7 in.×0.3125 in.×18 in.=212 cubic in.

RPM produced at 11 cycles/second×4 cylinders×60 seconds×97.3 Cubic in.=212 Cubic in.=1,210 RPM.
The average gasoline torque for the invention is: 880.3 pounds-Ft.
Therefore the HP's produced are 880.3×1,210 RPM=5252=203 HP
Resulting 13 cycles per HP produced.

For the regular motor this would be

481 Pounds-Ft×4,000 RPM=5252=366.4 HP Consequently 8,000 cycles=366.4 HP, giving a 21.8 Cycles per HP.
Then comparing 13 cycles/HP against 21.8 cycles/HP.
Resulting in an efficiency of at least 40% in gasoline motors.

In the case of Diesel Motors, for the invention:

The dimensions for the working vanes of the torquing drum are the same as above:
Vane 104 protrusion from the drum:
0.375 in.×18 in.=6.75 Sq.-In. Area under oil pressure
Vane 103 protrusion from the drum:
0.25 in.×18 in.=4.5 Sq.-In. Area under oil pressure
Vane 102 protrusion from the drum:
0.125 in.×18 in.=2.25 Sq.-In. Area under oil pressure
Vane 101 protrusion from the drum:
0.0625 in ×18 in.=1.125 Sq.-in. Area under oil pressure
Total working area: 14.625 Sq-In.

The total amount of oil to be displaced to move the drum one revolution is: 37.7 in.×0.375 in.×18 in.=254.5 cubic-in.

RPM produced at 9 cycles/second×4 cylinders×60 seconds×97.3 Cubic in.=254.5 Cubic in.=825 RPM

The average diesel torque for the invention is: 1,599 pounds-Ft. Therefore the HP produced are 1,599×825 RPM=5252=251 HP

Using 8.6 cycles per HP produced.

For the regular diesel motor this would be

591 Pounds-Ft×2,000 RPM=5252=225 HP Consequently 4,000 cycles=225 HP, gives 17.7 cycles per HP
Then comparing 8.6 cycles/HP against 17.7 cycles/HP.
Resulting an efficiency of at least 51% in diesel motors.

The working vanes have some area exposed to the high pressure chamber 13, this push them around and make the drum 100 rotate.

### Sources of Supplies.

There are several sources of supply for the components of the invention, in Diesel, Gasoline, natural gas, etc. all of them are well-known. For the batteries, compressors, vacuum pumps, cooling fans, diaphragm, gear box, ball bearings, radiator, alternator, and any other. The most important are the manufacturer of the combustion engine itself, this can be Hundai, Skania, Cummins, Perkin, Volvo and many other well-known brands.

The manufacturer of the engine block, Karan Motors (India), the manufacturers of the vane pump devices, which the most important are: Anson Hydraulic Industrial (Taiwan). AxFlow London (UK). Kurt J. Lesker Co., Jefferson Hill (PA). Parker Hannifin (France). For fuel injectors, common rail, and pumps Robert Bosch (Germany). The oil filters, Alfa Laval (Sweden). For the oil replenisher normally call constant-level oiler, Oil-rite corp. (WI), And others in different countries.

### Alternative Embodiment

Only one alternative embodiment is presented in FIG.-18, but many can be produced, changing the location of the vane torquing device 15, changing the location of the solenoids, providing a slightly different torquing vane device and modifying the combustion engine itself. The concept remain and with the ultimate advances in computers and electronic the invention will be easily designed and manufactured.

### CONCLUSION

The use of new technologies as microprocessors, solenoids and electronic controls coupled with new advances in combustion engines, oil and filters and the use of the best torquing device available, will allow us to create a more efficient motor which will contribute to produce more mechanical energy with less fossil fuel.

1. A two-stroke internal combustion hydraulic engine filled with a hydraulic oil, said engine comprising of:
a cylinder in fluid communication with a high pressure chamber;
a free floating piston disposed with the cylinder, the free floating piston is configured to direct the hydraulic oil to the high pressure chamber;
a vane torque device in fluid communication with the high pressure chamber, the vane torque device, having:
a cylindrical drum;
a plurality of vanes sliding engaged with the drum;
a metal plate configured to cause the pluralities of vanes to slide towards a center of the drum during rotation; and
an output shaft secured to the cylindrical drum;
a solenoid actuated valve disposed within the cylinder and in fluid communication with the torque device, the solenoid actuated valve being configured to slidingly engage with the cylinder, which in turn provides fluid passage between the torque device and the cylinder; and
a plurality of components connected to the engine;
wherein the free floating piston directs the hydraulic oil from the cylinder to the high pressure chamber, which in turn is directed to the vane torque device; and
wherein the hydraulic oil from the high pressure chamber rotates the output shaft via the plurality of vanes secured to the cylindrical drum.

2. The engine of claim 1, wherein two-stroke engine means an engine with a cycle composed only by combustion and exhaust strokes, and further comprising:
a) a common rail air compressed pipe, connected to each combustion chambers through a passage, each controlled by poppet valves to introduce high compressed fresh air to the combustion chamber before the combustion stroke, and
b) a common rail vacuum pipe, connected to each of the combustion chambers through a passage each controlled by poppet valves.

3. The engine of claim 1, wherein internal combustion hydraulic engine mean an engine comprised by:
a) an internal combustion motor that uses predetermined fossil fuel for the combustion stroke, said motor is adequately filled with hydraulic oil and that for each combustion stroke said oil is used to transmit power from said free piston to a vane torque device.

4. The engine of claim 1, Wherein the motor has at least two in-line unique cylinders mean that after that, an even or uneven in line number of said cylinders can be used, and that each unique said cylinder, have a combustion chamber on top and a piston who can move freely being pushed by the strokes inside said cylinder.

5. The engine of claim 1, Wherein said unique cylinders mean cavities in the motor block which on the top of each, there is a combustion chamber, said combustion chamber will receive oxidants and any type of cylinder down, said piston can move freely in the circular section of the cylinder.

6. The engine of claim 5, wherein said combustion chambers can be designed to use any type of fossil fuel either injected or premixed and comprise of:
a) a plurality of orifices on top, to allow the intake of fresh air and fuel and the exhaust of gases resulting from the combustion, plus orifices for a spark and glow plugs as needed;
b) attenuator devices in the combustion chamber, to protect the combustion chamber from the impact of the free piston in its way to TDC position and limit the production of noise;
c) poppet valves controlled by solenoids, whereby the intake and exhaust operation are governed, and
d) a high-pressure fuel injectors, glow plugs and spark plugs as needed.

7. The engine of claim 1, wherein said in-line cylinders means cavities comprising of:
a) cylinders composed by a circular section at the top, and a square section at the bottom;
b) cylinders having a hit and noise attenuator ring device at the bottom of the circular section, to stop the free piston in its way down to BDC position;
c) cylinders having an opening in one of their square section, for a check-in gate valve, and
d) cylinders that have small protruding flanges on the perimeter of the lower square portion, to support a check-out valve mechanism.

8. The engine of claim 7, wherein in said opening in one of their square section of the unique cylinder, there is a gate belonging to the check-in valve mechanism vertically located in the square portion of the cylinder block, means that it open and close rapidly being actuated by a solenoid.

9. The engine of claim 8, wherein having a check-in valve vertically located in the square portion of the cylinder block, means allowing oil to enter from the open low-pressure oil chamber to said square portion of the cylinder, thereby pushing said free piston to TDC position.

10. The engine of claim 1, wherein said cylinders are open in a lower square portion and at a perimeter of the border, have a plurality of small protruding flanges to support a check-out valve horizontally located, being actuated by a solenoid and/or springs, and that this mechanism allow said motor to be as boxy and compact as it could possibly be.

11. The engine of claim 10, wherein said metal windows-blind type of valve mechanism open and close rapidly, being actuated by a solenoid, which at the time of the combustion stroke allows the hydraulic oil to move from said unique cylinder to an open high-pressure oil chamber, said open chamber means is open to the other unique cylinders.

12. The engine of claim 2, wherein a common rail compressed air and vacuum pipes have direct access to the combustion chamber, and help in the combustion and exhaust strokes thereby avoiding a scavenging process, and allowing total compression-ratio flexibility in the design of said motor.

13. The engine of claim 11, wherein said metal window-blinds type of check-out valve mechanism open and close rapidly coupled with said common rail compressed air and vacuum pipes mechanisms connected with each combustion chamber, allowing said motor to produce the highest number of cycles per minute.

14. The engine of claim 1, further comprising:
a straight metal vane torque device which is located inside a motor mechanism, and submerged in oil and in full contact with an open high and low-pressure chambers, and located parallel to the in-line cylinders, and all along the length of said motor, being hold inside said motor by a shaft going through the wall of the motor block and through the center of the circular section of the cylindrical drum, working in conjunction with the other mechanism, said vane torque device is incorporated inside the main embodiment of said motor, either in the lower right side or the left side, eccentric or just below said motor.

15. The engine of claim 14, Wherein said straight metal torque vane device comprises of:
a) a rotating drum with straight cavities radially located along the cylindrical portion;
b) straight metal vanes around and radially located in the cavities of said cylindrical drum;
c) springs located inside the cavities to push said vanes outside, being stop by metal guides, and
d) a shaft located in the center of the circular section of said cylindrical drum.

16. The engine of claim 15, Wherein said metal guides mean curved metal plates located perpendicularly to said cylindrical drum, said metal guides can be a plurality of them and are attached to the block of said motor, said metal guides force the vanes to slide into their position.

17. The engine of claim 14, wherein said open high-pressure oil chamber means an oil chamber located below said unique cylinders and below the check-out valve mechanisms, means a chamber located just before said vane torque device, whereby is open to all the check-out valves of the unique cylinders.

18. The engine of claim 14, wherein said open low-pressure oil chamber means an oil chamber located after said torque vane device and before the check-in valve mechanisms located in said square portion of the unique cylinders, thereby is open to all the check-in valves of the unique cylinders.

19. The engine of claim 14, wherein submerged in hydraulic oil means said motor is adequately filled with hydraulic oil means the oil inside the motor embodiment fill all the spaces except the spaces left by the combustion chambers and the variable space between the combustion chamber and the space left by said free pistons in their movement means the combustion chambers and its expansion due to the combustion and exhaust strokes.

20. The engine of claim 14, wherein said a torque vane device located inside the motor mechanism and in full contact with the open high and low-pressure chambers, said vane type device which is used to produce torque using the high-pressure oil to push and move said vanes in its way to the low-pressure chamber, said oil pressure is produced by the free piston means generated by the combustion stroke, thereby said movement of said vanes make the drum turn and produce torque in the embedded shaft.

21. A two-stroke internal combustion hydraulic engine adequately filled with hydraulic oil, said engine comprising of:
a cylinder in fluid communication with a high pressure chamber;
a free floating piston disposed within the cylinder, the free floating piston is configured to direct the hydraulic oil to the high pressure chamber;
a vane torque device in fluid communication with the high pressure chamber, the vane torque device, having:
a plurality of vanes slidingly configured to rotate an output shaft;
a solenoid actuated checkout valve configured to open and close passage between the cylinder and the high pressure chamber;
wherein the free floating piston directs the hydraulic oil from the cylinder to the high pressure chamber, which in turn is directed to the vane torque device; and wherein the solenoid actuated checkout valve controls the hydraulic oil between the cylinder and the high pressure chamber.

22. The engine of claim 21, wherein the sealed motor means with only orifices needed to connect essential components for its functioning comprising: air compressor, vacuum exhaust, oil replenisher, oil filter arrangement, fuse assembly, diaphragm, electronic control unit, battery, alternator, cooling system, fuel pump, gas tank, and a multitude of other components.

23. The engine of claim 22, wherein said oil replenisher mean a mechanism to replenish said oil inside the main embodiment while in operation, means the volume amount of oil inside the embodiment must remain constant.

24. The engine of claim 22, wherein said oil filter arrangement, means an assembly with an intake inside the high-pressure chamber and coming outside the main embodiment to a location that can be very accessible, thereby as it is possible the longest.

25. The engine of claim 22, wherein said diaphragm means a metal cylindrical type of diaphragm, preset at the factory that can be fixed in the high or/and lower pressure chambers, with the purpose of maintain a smooth operation and absorbing the high-pressure oil spikes.

26. The engine of claim 22, wherein said electronic control unit is essential for the management of the solenoids working directly with said poppet valves and said check-in and out valves, said electronic control unit control their actioning, thereby they will control the work of the engine in each situation, said mechanism coupled with a microprocessor, will add more functional flexibility, thereby allowing said engine to be used in any region in the world.

27. The engine of claim 22, wherein said fuse assembly means a high-pressure fuse component, connected to said high-pressure oil chamber, means that said fuse will protect the embodiment in case said oil pressure is outside the permitted boundary set at the factory, means that said fuse will protect the embodiment and all the mechanisms connected.

28. The engine of claim 21, wherein said two-stroke combustion hydraulic engine, can be particularly designed to use any predetermined type of fossil fuel, with as many cylinders and with a wide range compression-ratio, thereby said engine can be used for any purpose in any region of the world.
